(19) United States
(12) Patent Application Publication
(10) Pub. No.: US 2010/0188665 A1
(43) Pub. Date: Jul. 29, 2010

(54) Methods and systems for interferometric analysis

(75) Inventors: Stephen Dotson, Montara, CA (US); Kirk C. Odencrantz, Eagle, ID (US)

Correspondence Address: Quine Intellectual Property Law Group, P.C., P.O. Box 458, Alameda, CA, 94501, US

(73) Assignee: Molecular Sensing, Inc., Montara, CA (US)

(21) Appl. No.: 12/655,898

(22) Filed: Jan. 8, 2010

Related U.S. Application Data
(60) Provisional application No. 61/144,112, filed on Jan. 12, 2009.

(51) Int. Cl. G01N 21/41

(52) U.S. Cl. 356/517

(57) ABSTRACT

This invention provides methods and devices for analyzing interference patterns. The methods include fitting a Gaussian distribution to a cross correlation of two patterns from interferometric analysis of a liquid at a first and second time; identifying a positional shift of the pattern by comparing a selected value of the Gaussian distributions of the pattern at the first and second times; and determining a change in refractive index of the liquid from the positional shift. In another aspect, a method of extending the dynamic range of an interferometric data set is provided that comprises linearizing the data set, for example, using the arcsine function.

### CROSS-REFERENCE

This application claims the benefit of the priority date of U.S. Provisional patent application 61/144,112, filed Jan. 12, 2009.

### BACKGROUND OF THE INVENTION

Back-Scattering Interferometry (BSI) is a highly sensitive refractive index (RI) detection technology that utilizes an illumination source, a fluidic micro-channel, and a detector. A fringe pattern, a series of bright and dark spots, is created by positive and negative interference of the light on the fluidic channel. The shift in these fringes corresponds to a change in RI. When biomolecules, such as proteins, DNA, RNA, or some molecules, such as drugs, toxins, xenobiotics, allergens, and so on, interact with each other or with other targets, a BSI binding signal is created, resulting in a measured alteration in refractive index. BSI molecular interaction measurements can be performed in a homogeneous manner (free solution approach or untethered approach in which none of the interactors are physically bound to a solid support) or in a heterogeneous manner (tethered approach in which at least one of the interactors is bound to a solid support). Applications of BSI as well as its technical basis have been well described by Bornhop et al.

As BSI devices are developed and advanced, images can be obtained from a photodetector at increasingly greater speeds. However, in order to more accurately detect molecular interactions or other biological reactions with BSI, it is necessary to obtain an accurate measurement of the positional shift of the fringe patterns. As mentioned, a positional shift of the fringe pattern can indicate a change in RI of a liquid sample. For example, antibodies in the liquid sample can bind to antigens, and the reaction can be monitored by BSI. However, if the fringe positional shift is slight between successive images, the positional shift may not be detected by current analysis techniques used for BSI analysis. This can occur because the positional shift may be less than the pixel resolution of the photodetector. In addition, there may be issues with phase wrap as the fringe position shifts.

There is a need in the art for methods and systems that can provide sub-pixel resolution of fringe positional shifts while being flexible to adapt for any phase wrapping. Methods and systems that can provide these capabilities should allow for more accurate detection and analysis of molecular interactions by interferometry.

### SUMMARY OF THE INVENTION

In an aspect, a method is disclosed herein for determining a change in refractive index of a liquid comprising: fitting a Gaussian distribution to a cross correlation from a pattern from interferometric analysis of a liquid at a first and second time; identifying a positional shift of the pattern by comparing a selected value of the Gaussian distributions of the pattern at the first and second times; and deriving a change in refractive index of the liquid from the positional shift.

In an embodiment, a method before fitting the pattern further comprises capturing a fringe pattern generated from a sample at two different times with a photodetector and optionally performing a function on the pattern.

In some embodiments, a method comprises implementing a Hamming window on the fringe pattern prior to fitting the fringe pattern to the Gaussian distribution, wherein implementing a Hamming window reduces noise in the Gaussian distribution.

In some instances, the pattern is a cross-correlation of two interferometric fringe patterns.

In some embodiments, the selected value is the maximum value.

A method herein can further comprise: providing a substrate having a compartment formed therein for reception of the liquid and injecting the liquid into the compartment; directing a coherent light beam onto the substrate such that the light beam is incident on the compartment containing the liquid to generate backscattered light; and detecting the backscattered light, wherein the backscattered light comprises a fringe pattern whose position may shift in response to changes in the refractive index of the liquid. Detecting is carried out by a photodetector having a pixel resolution and positional shifts may be indentified in sub-pixel resolution. The coherent light beam can arise from a laser, for example with a beam diameter of 2 mm or less.

The temperature of a liquid can be measured from the change in refractive index of the liquid.

A first and second biochemical species and whether the first and second biochemical species interact with one another can be monitored by monitoring the change in refractive index of the liquid. In some instances, the first and second biochemical species are selected from the group comprising complimentary strands of DNA, complimentary proteins, drug molecule-receptor pairs, ligand-receptor pairs, and antibody-antigen pairs.

Methods herein can provide monitoring of whether a ligand in a liquid binds with one or more receptors by monitoring the change in refractive index of the liquid.

In another embodiment, a method can comprise analyzing a label-free hybridization reaction in a liquid by analyzing the change in refractive index of the liquid.

Analyzing a chemical or enzymatic reaction between two or more molecules can be completed by monitoring the change in refractive index of a liquid.

In an embodiment, a method provides analyzing a structural or conformational change of a molecule by monitoring the change in refractive index of a liquid.

In an aspect, a system is provided for determining a characteristic property of a liquid that comprises: a device configured to detect a fringe pattern generated from a liquid; and a processor configured to receive information from the device, wherein the processor is configured to execute a set of instructions for processing the fringe pattern at more than one time by fitting the fringe pattern to a Gaussian distribution.

The processor can be a component of a computer system and the computer system can be configured to control the operation of the device.

In an embodiment, the set of instructions when executed subject the fringe pattern to a Hamming window analysis prior to fitting the fringe pattern to a Gaussian distribution.

In another embodiment, the processor is configured to execute a set of instructions that when executed compare fringe patterns at a first time to fringe patterns at a second time.

In some instances, the device has a pixel resolution and the comparison of fringe patterns at the first and second times has a sub-pixel resolution.

The device can be an interferometer that can comprise: a coherent light source; and a sample compartment for receiving the liquid, wherein the compartment is configured for analysis of the liquid therein by back-scatter interferometry when interrogated by coherent light beam from the coherent light source.

In an aspect, a method comprises: collecting a data corresponding to a positional shift of a fringe pattern from an interferometer, wherein the data extends over more than one period; fitting the data to an arcsine function using a computer system; and converting the arcsine function of the data with the computer system to a line with an positive slope when the data is increasing and a negative slope when the data is decreasing. A method can further comprise: normalizing the data before fitting the data to the arcsine function; and correcting for the normalization after converting the arcsine function of the data to the line. A step of converting the arcsine function of the data to a line can comprise cumulatively adding the positive change in value for positive slope portions and the positive change of inverse of the change in value of the negative slope portions to the positive portions when the data is increasing.

In another aspect, a method is disclosed comprising: monitoring data corresponding a positional shift in a fringe pattern over time measured from a liquid, wherein the positional shift changes direction at a point in time; performing a linearization of the data, thereby creating a line with a positive slope when the positional shift is increasing and a negative slope when the positional shift is decreasing. A method can further comprise identifying a change in refractive index of the liquid from the line. In some instances, a method further comprises: normalizing the data before performing the step of linearizing; and correcting for the normalization before the step of identifying.

In an aspect, a method comprises: linearizing inferometric data that extends over at least two periods with a computer system; and analyzing the interferometric data set.

In an aspect, a system comprises: a) an optical assembly configured to generate backscattered light comprising a fringe pattern from a sample; b) an optical detector configured capture first data about the fringe pattern generated at a first time and second data about the fringe pattern generated at a second time; c) a signal analyzer configured to receive the first and second data from the optical detector into memory and comprising computer-executable code that: (i) performs a cross correlation on each image in memory with a reference data and fits a Gaussian distribution to each cross correlation; and (ii) determines selected values of the Gaussian distributions of the cross correlations, wherein the selected values indicate a position of the fringe pattern. In one embodiment the first and second data comprise first and second images of the fringe pattern. In another embodiment the system further comprises: d) a display configured to display the selected values in a format indicating the relative positions of the fringe patterns at the first and second times. In another embodiment (c) the signal analyzer further comprises computer-executable code that: (iii) determines from the selected values a change in the position of the fringe patterns; and the system further comprises a display configured to display the change.

In another aspect, a system comprises a) an optical assembly configured to generate backscattered light comprising a fringe pattern from a sample; b) an optical detector configured to capture data about the fringe pattern generated over a time during which the fringe pattern shifts over more than one period; c) a signal analyzer configured to receive into memory the data, e.g., images, from the optical detector; and comprising computer-executable code that: (i) determines values indicating positions of the fringe pattern over the time; (ii) fits the values to an arcsine function; and (iii) converts the fitted values to a line with a positive slope when the values are increasing and a negative slope when the values are decreasing. In one embodiment the data comprises an image of the fringe pattern. In another embodiment the processor further comprises computer-executable code that: (iv) normalizes the values before fitting them to the arcsine function; and (v) corrects for the normalization after converting the arcsine function of the values to the line. In another embodiment the system further comprises: d) a display configured to display at least a portion of the line. In another embodiment the signal analyzer further comprises computer executable code that: (iv) determines from the fitted values points at which the slope of the line changes; and the system further comprises a display configured to display the points.

In an aspect, this invention provides computer readable medium comprising computer executable code that: (i) accesses from computer memory first data the fringe pattern generated at a first time and second data about the fringe pattern generated at a second time; (ii) performs a cross correlation on each image in memory with a reference image and fits a Gaussian distribution to each cross correlation; and (iii) determines selected values of the Gaussian distributions of the cross correlations, wherein the selected values indicate a position of the fringe pattern. In one embodiment the first and second data are first and second images of the fringe pattern.

In another aspect, this invention provides a computer readable medium comprising computer executable code that: (i) accesses from computer memory data about a fringe pattern generated over a time during which the fringe pattern shifts over more than one period; (ii) determines values indicating positions of the fringe pattern over the time; (iii) fits the values to an arcsine function; and (iv) converts the fitted values to a line with a positive slope when the values are increasing and a negative slope when the values are decreasing. In one embodiment the data are images of the fringe pattern.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Many features of the invention are set forth with particularity in the appended claims. A better understanding of the features and advantages of the invention will be obtained by reference to the following detailed description that sets forth illustrative embodiments, in which many principles of the invention are utilized, and the accompanying drawings of which:

FIG. 1 illustrates a fringe pattern that is a sine wave.

FIG. 2 demonstrates a Fourier Transform of the sine wave of FIG. 1 and provides the amplitudes of each frequency and the phase of each frequency, wherein the dominant frequency can be observed.

FIG. 3 depicts an example of how an algorithm can be utilized according the methods and systems herein.

FIG. 4, panels 1-10, shows a full cycle fringe shift. The left-most fringe in panel 1 shifts leftward and off the detector by panel 10.

FIG. 5 illustrates an exemplary fringe pattern.

FIG. 6 illustrates the results of correlating a similar image to a reference image.

FIG. 7 depicts a method and system as described herein that fits a Gaussian distribution to a cross correlation.

FIG. 8 shows the maximum peak area of the cross-correlation can have a Gaussian distribution fit.

FIG. 9 depicts a method and system as described herein that fits a Gaussian distribution to a cross correlation of patterns with a Hamming window applied.

FIG. 10 illustrates a sine wave output as generated.

FIG. 11 shows converting the output of FIG. 10 with the arcsine function.

FIG. 12 demonstrates generating a linear output over a large detection range by Point B-Point A+previously calculated point in the positive arcsine direction and Point A-Point B+previously calculated point in the positive arcsine direction.

FIG. 13 depicts an exemplary method described herein for correcting sinusoidal data in order to increase the dynamic range of analysis.

FIG. 14 depicts a flow diagram of a BSI system.

FIG. 15 depicts an exemplary full BSI device configured for analyzing a blood sample.

FIG. 16 shows an exemplary experiment where different percent DMSO in water was introduced into the system.

FIG. 17 illustrates selected data from FIG. 16 showing a linear response over a large range.

FIG. 18 illustrates an example comparing that the Gaussian fit with and without the Hamming window.

FIG. 19 illustrates data generated by back-scattering interferometry over a 17.5 min time period with a sample with a large RI change being pushed through the system and a change in direction around 7.5 min.

FIG. 20 shows a method of normalizing wherein a value can be added to all the new signal data to center around the zero point.

FIG. 21 illustrates the arcsine of the normalized function from FIG. 20.

FIG. 22 illustrates the data as a curve encompassing a change in direction.

FIG. 23 shows the data from FIG. 22 scaled according the scaling factor from the exemplary experiment.

FIG. 24 shows a system for sample analysis in flowing streams.

### DETAILED DESCRIPTION OF THE INVENTION

### I. Interferometry Analysis

As provided herein, a method and improved algorithm is able to measure subtle shifts in fringe position as generated during back-scattering interferometry analysis over a large dynamic range of fringe shifts. In addition, shifts measured by the methods provided herein can be more independent of fringe pattern shape and the number of fringes as compared to other similar methods. The methods of this invention can be performed on any data derived from interferometric data, including raw data measurements (e.g., a fringe pattern) and data that has been cross-correlated.

Back-scattering interferometry (BSI) is a refractive index (RI) detector that utilizes an illumination source, a fluidic container, and a detector. A fringe pattern, a series of bright and dark areas, e.g., spots or bands, is created by positive and negative interference of the light on the fluidic container. The positional shift in these fringes corresponds to a change in refractive index.

Algorithms, methods, and techniques have been utilized to analyze the movement of the fringe pattern in back-scattering interferometry, including Fourier Transform and multiple variations of cross correlation. In the Fourier Transform technique, the detector is positioned to detect several fringes that have a single spatial frequency. The change in the position of the fringes corresponds to a change in phase of the frequency. In the cross-correlation techniques, a reference pattern is selected with which all other fringe patterns are compared, in order to detect a shift in the fringe pattern. In many instances, calculations are performed in such a manner that sub-pixel measurements are possible.

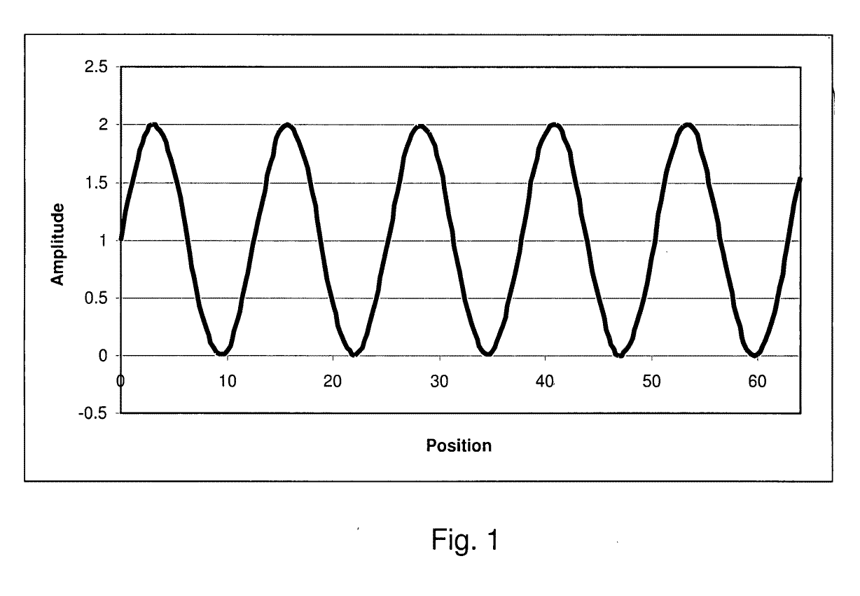

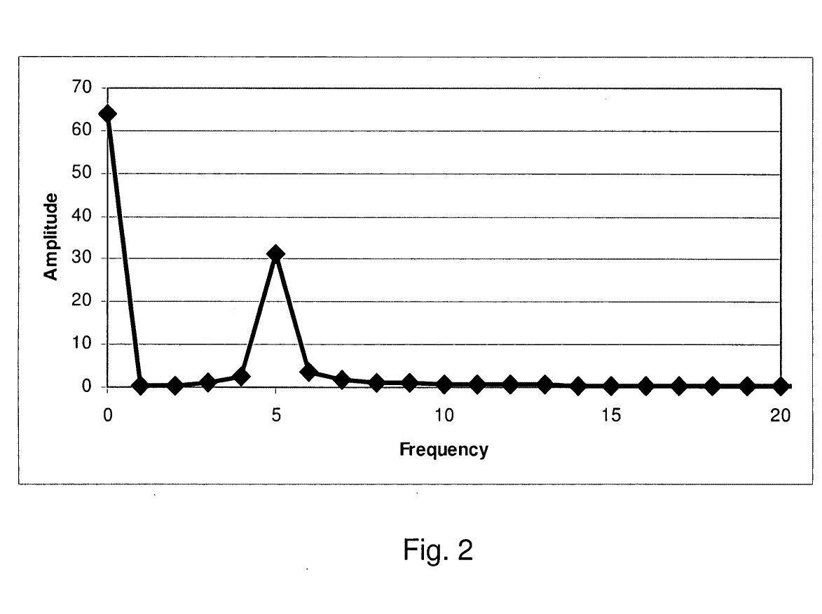

The Fourier Transform method of analyzing the data makes an assumption that the fringe pattern is a sine wave as shown in FIG. 1. A Fourier Transform can be performed, which breaks the fringe pattern down into frequencies. The Fourier Transform provides the amplitudes of each frequency and the phase of each frequency. By plotting the amplitude of each frequency as shown in FIG. 2, a dominant frequency can be observed. In order to obtain such a pattern from a fringe pattern from interferometry, alignment is necessary. Images of the five fringes shown in FIG. 1 correspond to the frequency 5 (number of fringes on camera). As shown in FIG. 2, the amplitude of the frequency 5 is high. By monitoring the phase of frequency number 5 over time, it is possible to monitor the shift of the fringe pattern. The output of the phase is limited to −pi to +pi and describe the shift of the frequency not the pixel shift of the fringe pattern.

In contrast, as described herein, the methods and systems provide a cross-correlation and Gaussian fit technique. Cross-correlation is an analysis technique that is often used in image analysis. It does not require that the fringe pattern conform to a certain pattern. A reference image can be taken that all new images can be compared to.

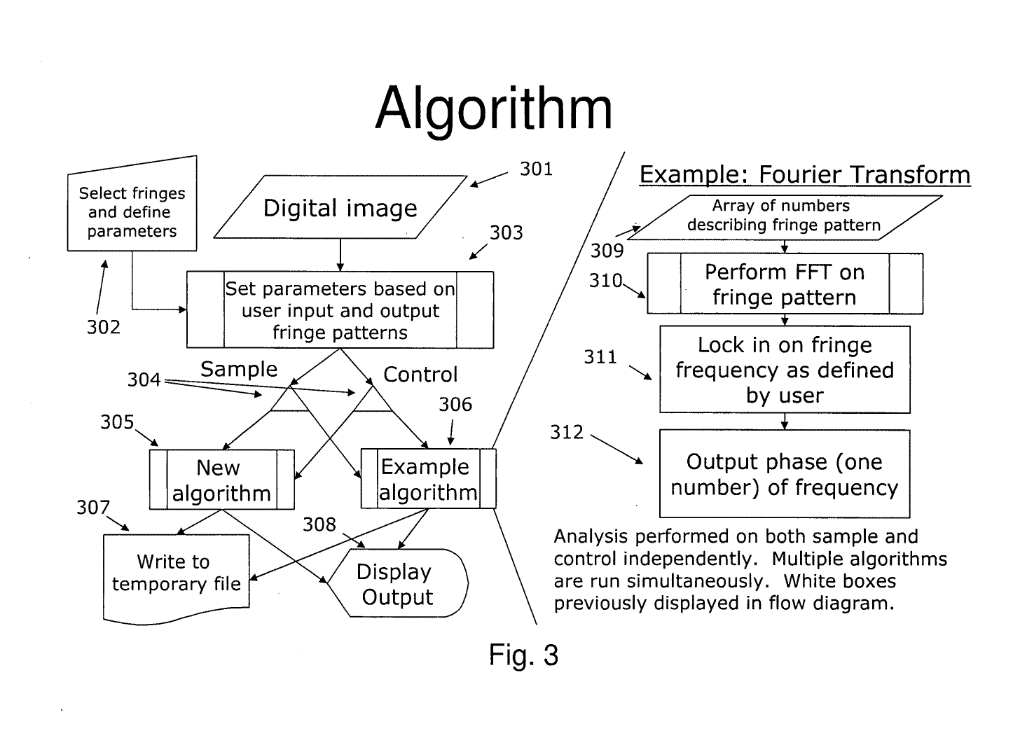

FIG. 3 depicts an example of how an algorithm can be utilized according the methods and systems herein. Interferometry, e.g., back scattering interferometry, produces an interferometric pattern referred to as a fringe pattern. The fringe pattern produced by a sample being analyzed is captured by a photodetector, such as a CCD camera, at a plurality of different times. The digital image 301 and user input for fringes and parameters 302 are used to select the regions from the digital image 301. The camera allows for two regions to be selected (for example, sample and control). In this example, FIG. 3 demonstrates a method of verifying and comparing 304 a method and system provided herein (new algorithm 305) and an algorithm known in the art (example algorithm 306), such as the Fourier Transform technique. The program allows, for example, for multiple analyses to be performed simultaneously. The data from these algorithms can be written to a temporary file 307 and displayed 308 in real time or on demand from a user. As described herein Fourier Transform data analysis can be used to detect positional shifts of fringe patterns and is used in many other analysis techniques, such as FTIR. The digital image output 308 can be utilized by the algorithm as an array or matrix of numbers that describe the fringe pattern 309. A Fast Fourier Transform can also be utilized and performed as demonstrated in this example 310. As described herein, in contrast to the new algorithm 305, the Fast Fourier Transform algorithm 306 requires locking in on the spatial frequency 311 as defined by the user in 302. Also as described, this can limit the algorithm's ability to handle data with a dynamic range and can limit the analysis to pixel-level positional shifts. The output of the algorithm is the phase of the spatial frequency 312. The algorithm can be applied to both the sample and reference data simultaneously.

A. Gaussian Analysis

In an aspect, a method is disclosed herein for determining a change in refractive index of a liquid comprising: producing an interferometric pattern, referred to as a fringe pattern, from a sample; capturing the fringe pattern produced with a photodetector, such as a CCD camera, at a plurality of different times; optionally transforming the pattern, e.g., by performing cross correlation, to produce a pattern for analysis; fitting a Gaussian distribution to the cross correlation for analysis at a first and second time; identifying a positional shift of the pattern by comparing a selected value of the Gaussian distributions of the pattern at the first and second times; and delivering a change in refractive index of the liquid from the positional shift. In some instances, the pattern is a cross-correlation of two interferometric fringe patterns. In other instances, the pattern is an interferometric fringe pattern. In an example, a Gaussian distribution can be fit to an individual fringe pattern for analysis without cross-correlating the data prior to fitting the data. In some embodiments, the selected value is the maximum value.

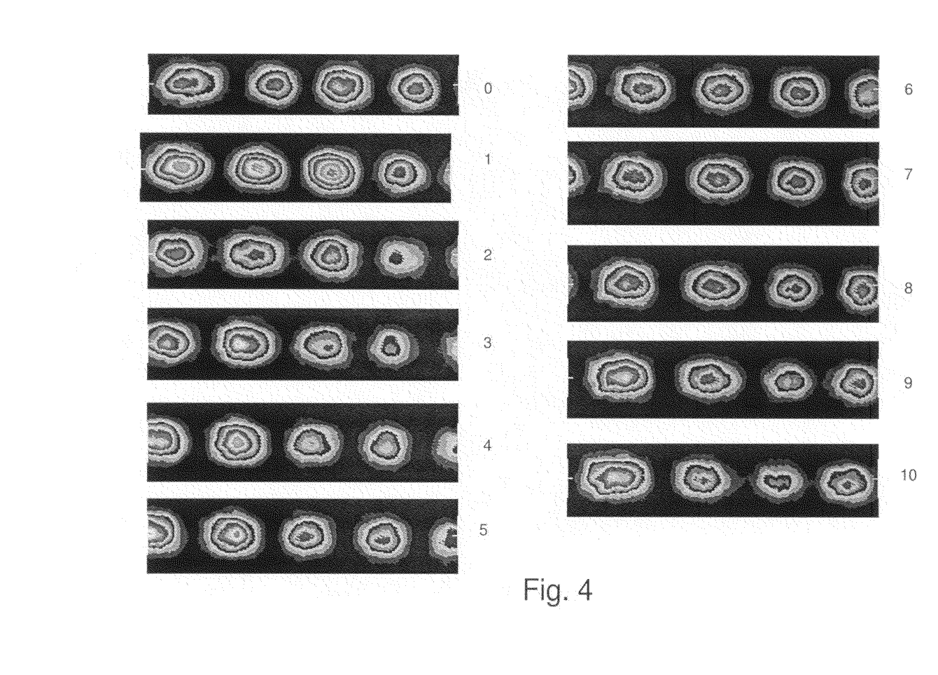

As provided herein, methods and systems are provided to analyze a slight movement of an interference pattern as detected by interferometry. The methods and systems can provide a linear response when detecting a positional shift of a fringe pattern. The positional shift of a fringe pattern can correspond to a change in refractive index of a liquid sample in the interferometer. FIG. 4 shows a full cycle fringe shift of a BSI device.

Fringe patterns generated from BSI are captured by a detector. A cross-correlation can be performed using the reference fringe pattern and the new fringe pattern detected at the current time. The position of the maximum value of the cross-correlation moves relative to the change in the position of the current fringe pattern to the reference fringe pattern. The positional shift of a fringe pattern can indicate a change in refractive index of the object or solution being monitored by interferometry. In some instances, the common use of the cross-correlation algorithm measures the location of the maximum value. By locating the position of the maximum value by this method, a standard cross-correlation technique is limited to a resolution of discrete pixel shifts of the fringe pattern as detected by a photodetector of an interferometer.

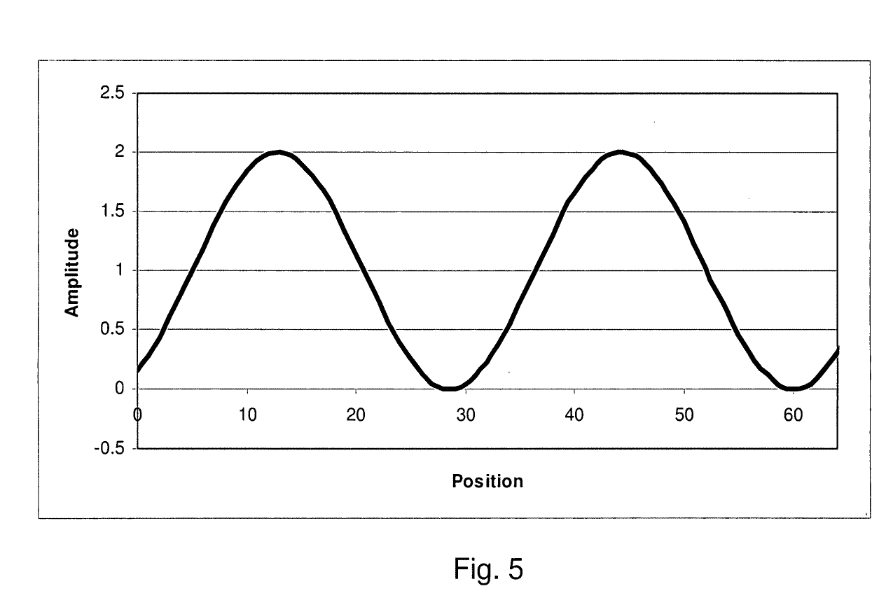

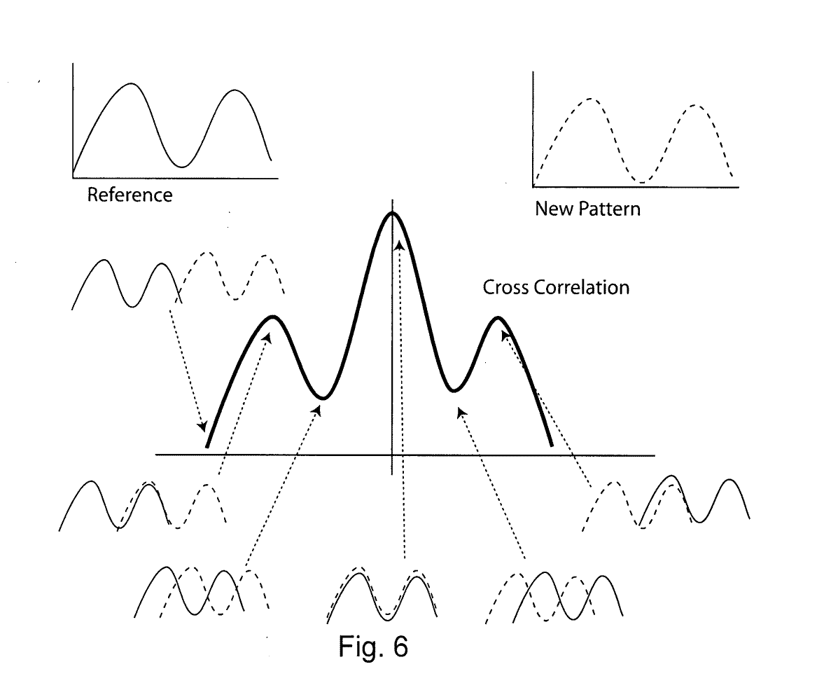

An exemplary fringe pattern is shown in FIG. 5. If the image to be correlated to the reference image is similar, the result is shown in FIG. 6. The center thick line shows a cross-correlation result. The two patterns are shown as they overlap each other to create the cross correlation. This cross-correlation method has been used previously for identifying positional shifts of fringe patterns, wherein the maximum of the cross-correlation was used to locate the highest correlation between the patterns. However, this method is limited to integers according to the pixels of the images.

In order to obtain sub-pixel resolution, the cross-correlation can be fit to a Gaussian distribution. The Gaussian equation is:

$$f ( x ) = a {e}^{- \frac{{( x - b )}^{2}}{2 {c}^{2}}}$$

The natural log of both sides can be taken to create a linear equation:

$$ln ( f ( x ) ) = ln ( a ) + ( - \frac{{( x - b )}^{2}}{2 {c}^{2}} )$$

$$or$$

$${f}^{′} ( x ) = {a}^{′} + ( - \frac{{( x - b )}^{2}}{2 {c}^{2}} )$$

Given f(x), a general linear least squares fit can be used to calculate b, which is the maximum of the Gaussian distribution.

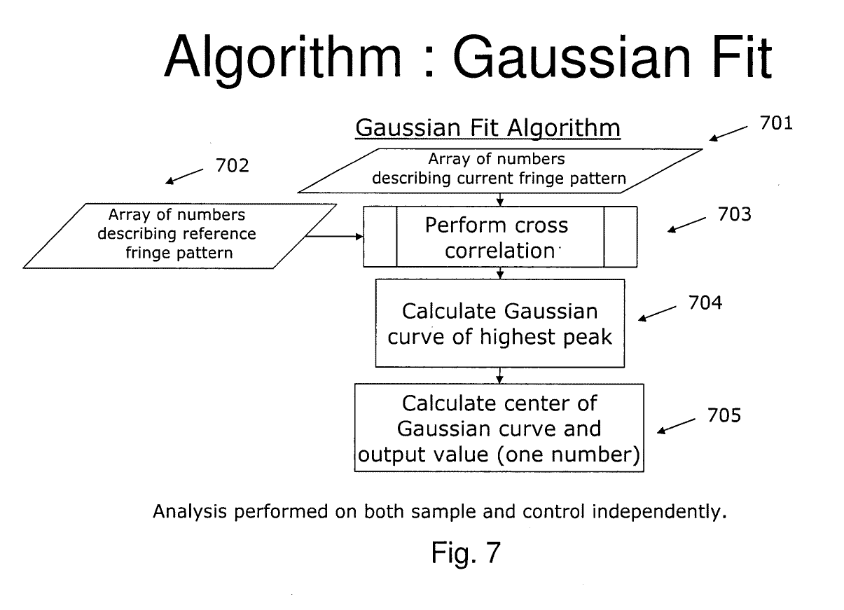

FIG. 7 depicts an exemplary method and system as described herein that fits a pattern to a Gaussian distribution. The array of numbers describing the fringe pattern 701 obtained from the digital image of the fringe pattern can be cross-correlated 703 with the reference digital image comprising an array of numbers describing a reference fringe pattern 702. As described herein, a Gaussian distribution can be fit to the maximum peak obtained from the cross-correlation step 704. In this manner, selected values of the Gaussian distribution can be used to compare the cross-correlation results to a previous Gaussian distribution of a cross-correlated fringe pattern. In this example, the center of the Gaussian fit is identified and then output 705. The output can be stored as described previously for analysis of positional shifts of the fringe pattern.

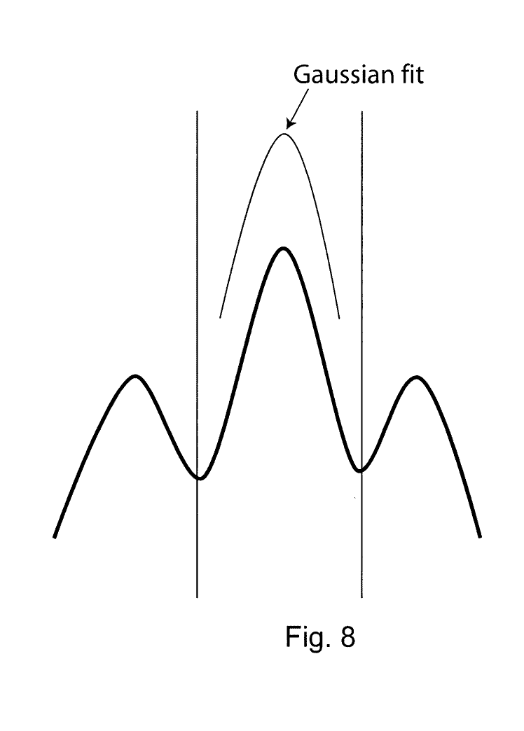

In some instances, as shown in FIG. 8, the maximum peak area of the cross-correlation can be fit to a Gaussian distribution. The mathematical center of the Gaussian distribution can then be determined. By monitoring the mathematical center over time, it is possible to obtain a shift value for the fringe patterns that may be sub-pixel in resolution. In other instances, the entire cross-correlation can be fit to a Gaussian distribution, for example, when analyzing a single fringe. A selected point of the Gaussian distribution can be used to compare each successive Gaussian distribution and detect the positional shift in the fringe pattern. In some instances, the analytical solution of the center of the Gaussian distribution is used as the selected point to calculate the fringe pattern shift.

In contrast to the standard cross-correlation techniques described herein, the methods and system of fitting a Gaussian distribution to a cross-correlation or fringe pattern, sub-pixel resolution of positional shifts of the fringe pattern can be obtained.

In some instances, other techniques, such as a center of gravity of the cross correlation highest peak, can also provide sub-pixel resolution. However, the center of gravity technique can suffer from non-linearity and gain issues depending on the fringe pattern shapes and the amount of shift in the fringe pattern.

In some embodiments, a method comprises implementing a Hamming window on the fringe pattern prior to fitting the fringe pattern to the Gaussian distribution, wherein implementing a Hamming window reduces noise in the Gaussian distribution.

As disclosed herein a method can comprise a modification of the Gaussian fit method comprising providing a Hamming window on a fringe pattern prior to performing a cross-correlation. The Hamming window is provided:

$$w ( n ) = 0.53836 - 0.46164 cos ( \frac{2 π n}{N - 1} )$$

The Hamming window is a weighting window that can be applied to the fringe patterns prior to performing the cross correlation of the reference fringe pattern and the sample fringe pattern as demonstrated herein:

F(n)=F(n)*w(n)

The hamming window can reduce the interference of the cross-correlation side peaks with the central peak of the cross-correlation. In some instances, the Hamming window may provide better results with a larger set of fringe pattern shapes. However, a Hamming window can create a loss of resolution when larger fringe shifts have occurred. In some instances, variations of the Hamming window shape, for example blending a square window with a Hamming curve, may reduce the noise and improve the results for the fringe pattern shapes commonly seen with back-scattering interferometry.

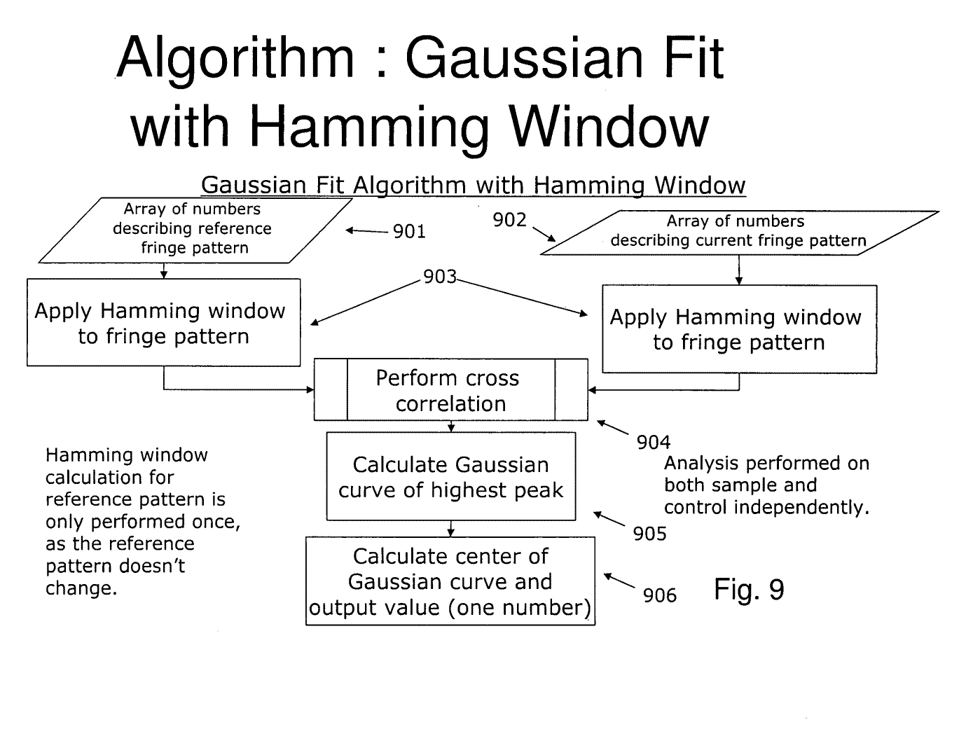

FIG. 9 depicts a method and system as described herein that fits a pattern to a Gaussian distribution with a Hamming window. Both the array of numbers describing the fringe pattern 901 and an array of numbers describing a reference fringe pattern 902 can have a hamming window applied 903. As described, applying a Hamming window to the selected fringe patterns may reduce noise, for example, from side peaks surrounding the selected fringe pattern. After a Hamming window has been applied to the digital images, a cross-correlation can be performed 904, as described herein and demonstrated in FIG. 9. As described herein, a Gaussian distribution can be fit to the maximum peak obtained from the cross-correlation step 905. In this manner, selected values of the Gaussian distribution can be used to compare the cross-correlation results to a previous Gaussian distribution of a cross-correlated fringe pattern. In this example, the center of the Gaussian fit is identified and then output 906. The output can be stored as described previously for analysis of positional shifts of the fringe pattern.

In some instances, the methods and systems provided herein can offer comparable results to the Fourier Transform and the modified cross-correlation program currently utilized in back-scattering interferometry. In some instances, the methods and systems provided herein offer more accurate comparisons of fringe patterns than any current existing techniques. The methods and systems herein can provide a sensitivity at the level of the cross-correlation method as well as offer linear results over a large range. Compared to the Fourier transforms, these algorithms do not require a single spatial frequency in order to function.

As disclosed herein, a method is demonstrated that allows the expansion of the upper dynamic range for reading backscattering interferometer analysis. The method can correct for the nonlinearity of a sinusoidal output to produce linear results.

A method described herein provides linear results over multiple fringe wraps, where previously data was limited to fringe counting. This correction was designed for the cross-correlation algorithm that until this time had no means of extending the dynamic range. An example of fringe counting is included in U.S. Pat. No. 6,559,947.

In an aspect, a method as described herein can expand the dynamic range of any data set with a sinusoidal output. For example, the output can be fringe patterns detected from an interferometer.

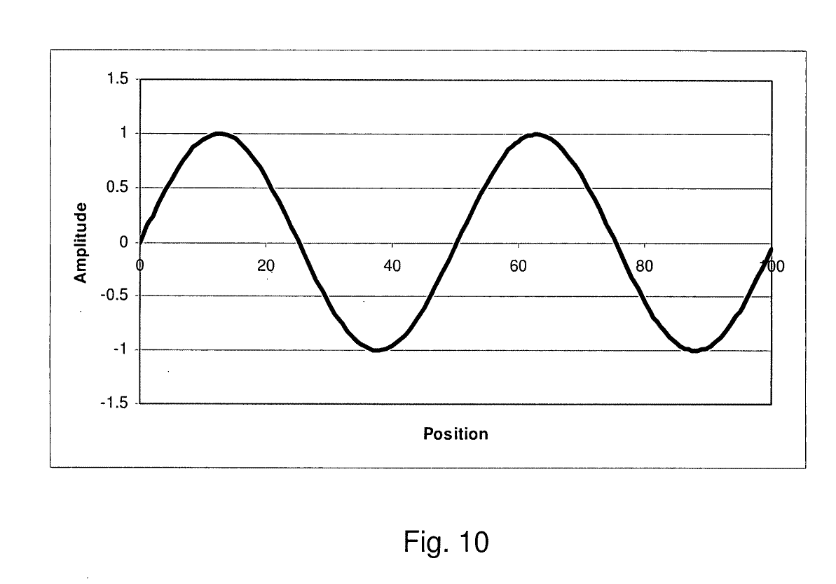

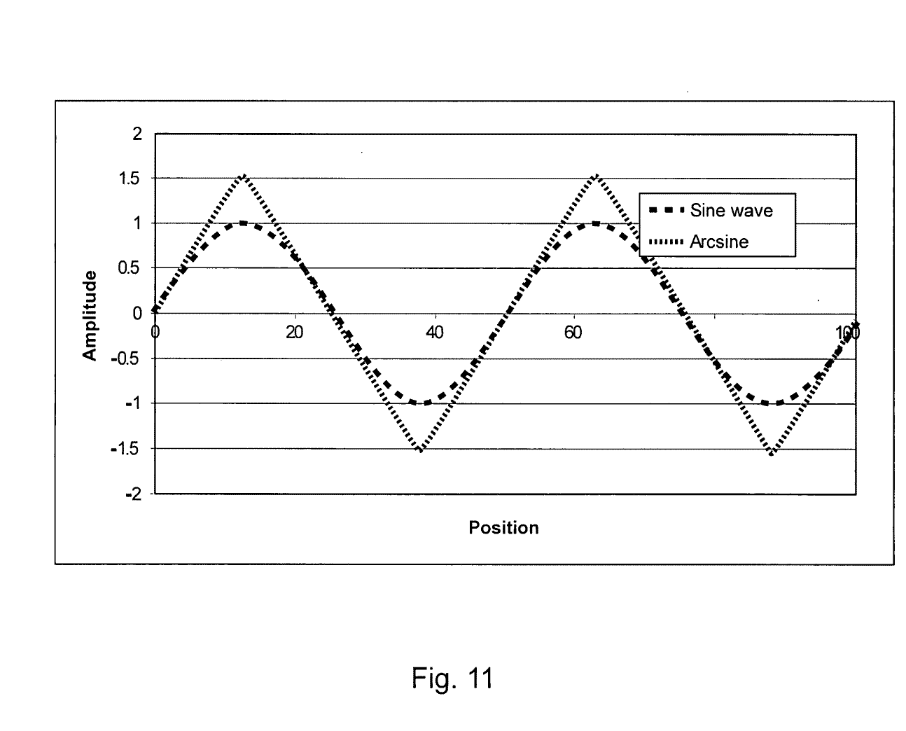

As an example, FIG. 10 illustrates a sine wave output as generated. In order to maintain the near linear sections and the correct for the maximum and minima, which are rounded, the arcsine function can be utilized as shown in FIG. 11. In order to use the arcsine function, all values must be between 1 and −1. Therefore, normalization of the sinusoidal data output may be necessary. Normalization can be performed by using a scaling factor in order to have all the values fall between 1 and −1.

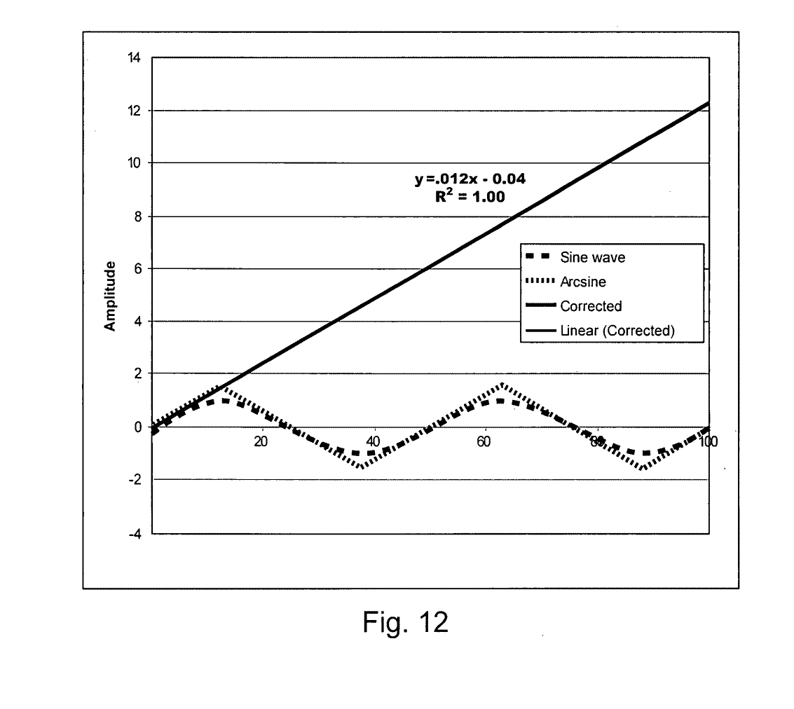

In this example, with the pattern now as linear sections, the negative slopes can be inverted and they can be added to the previous calculated value. In addition, when the slope becomes positive again, the next linear section can be added to the previous values as demonstrated in FIG. 12. For any two points, A and B and the previously calculated value follow the following equations: Slope negative: point A-point B+previously calculated point. Slope positive: point B-point A+previously calculated point. Point B becomes point A for the next calculation and the next value in the series becomes B.

The linearity of the line may be dependent upon accurately describing the sine wave, or translated to data acquisition an appropriate frame rate. Fringe counting may allow similar expansion of the upper dynamic range of sinusoidal output from an interferometer, but would not correct for the nonlinear signal output and provide less accurate results. Also a linear signal response would be able to be combined corrected in a similar manner as this one, by adding a constant value each time the fringes wrap.

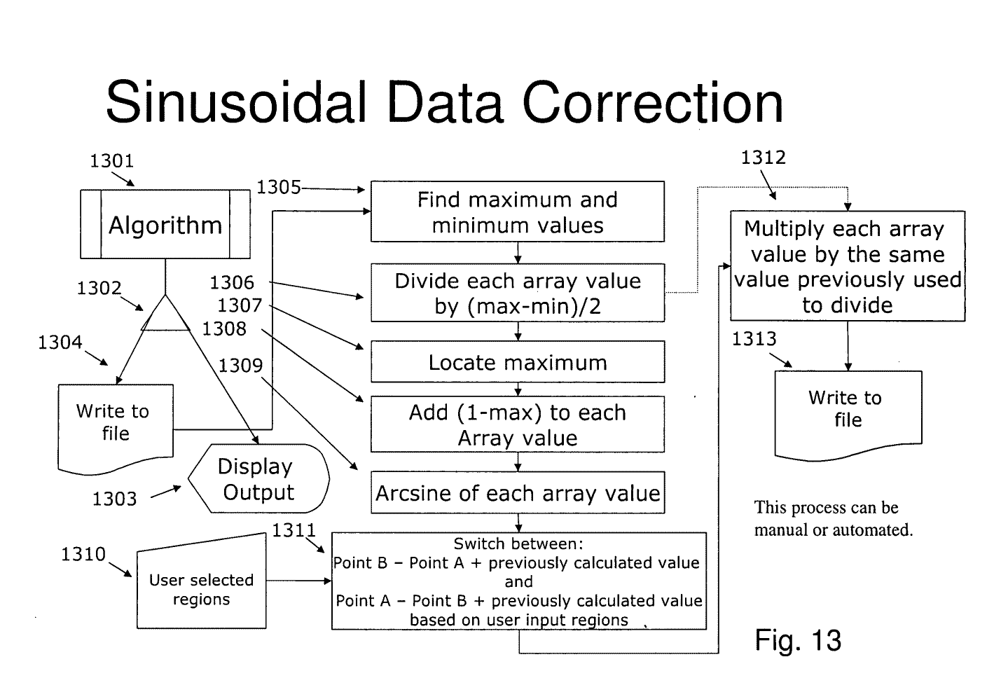

FIG. 13 depicts an exemplary method described herein for correcting sinusoidal data in order to increase the dynamic range of analysis. After analyzing the data using a method described herein or other interferometric analysis 1301, the data can be split 1302 to an output 1303, such as a display, and written to a file 1304. Using a sinusoidal data correction method as described herein, the maximum and minimum values can be found 1305. In this example, in order to normalize the data, each value 1306 is divided by (max-min)/2 then the new maximum is located 1307. The (1-max) is added to each array value 1308 (center around 0). After normalizing the data, the arcsine of each array value is taken 1309. In order to generate a linear function and analyze data that may contain a phase wrap, the method can switch between Point B-Point A+previously calculated value and Point A-Point B+previously calculated value 1311. The user may also select regions to be analyzed 1310. In order to correct the data for the normalization performed previously, the method multiplies each array value 1312 by the same value that was used to divide in 1306. The data can then be written to a file 1313 and provided to a system or a user.

### II. Systems

A method herein can further comprise: providing a substrate having a compartment formed therein for reception of the liquid and injecting the liquid into the compartment; directing a coherent light beam onto the substrate such that the light beam is incident on the compartment containing the liquid to generate backscattered light; and detecting the backscattered light, wherein the backscattered light comprises a fringe pattern whose position may shift in response to changes in the refractive index of the liquid. Detecting is carried out by a photodetector having a pixel resolution and positional shifts may be indentified in sub-pixel resolution. The coherent light beam can be a laser, for example with a diameter of 2 mm or less.

The analysis methods described herein may also be useful with other types of interferometers and refractometers, besides BSI devices. Exemplary interferometers include a Young interferometer, wherein a beam is split into two parts, a sample and reference, typically in fibers. It is possible to pass the beam through the sample or use the evanescent wave property to obtain a surface bound effect. Once the beams escape the two fibers, a fringe pattern is formed. The change in the fringe pattern indicates changes in sample. This interferometer was extended to a four channel system which allows analysis of multiple channels simultaneously. (Ymeti, A. et al. Realization of a multichannel integrated Young interferometer chemical sensor. Applied Optics 42, 5649-5660 (2003)).

The Farfield Sensor is similar to a Young interferometer in that a beam is split into two waveguides that are stacked. In this case, a biological layer is placed on top of one of the waveguides. Thus changes in the layer produce a change in the fringe pattern. (FarfieldSensorLtd. The Fundamental Principles of the AnaLight System. (http://www.farfield-scientific.com/index.asp)).

Another exemplary interferometer is a Mach-Zehnder interferometer that uses a beam splitter to split a beam in two different directions. One beam path is used as a reference and the second is passed through the sample cell. The two beams are recombined and then directed onto a detector. (Heideman, R. G. & Lambeck, P. V. Remote opto-chemical sensing with extreme sensitivity: design, fabrication and performance of a pigtailed integrated optical phase-modulated Mach-Zehnder interferometer system. Sensors and Actuators B 61, 100-127 (1999)).

A Michelson interferometer uses the same half-silvered mirror to split and recombine the beam. The Mach-Zehnder interferometer (previously described) provides a more convenient means of adding a sample cell.

Most refractometers are used to measure liquids. Most refractometers use a prism and a cover plate to sandwich the sample. Light is then passed through and bent. Abbe refractometers are laboratory or research level refractometers and are more accurate than the common hand held. These typically require temperature control to ensure accuracy.

A. Back-Scattering Interferometer

In an aspect, a system is provided for determining a characteristic property of a liquid that comprises: a device configured to detect a fringe pattern generated from a liquid; and a processor configured to receive information from the device, wherein the processor is configured to execute a set of instructions for processing the fringe pattern at more than one time by fitting the fringe pattern to a Gaussian distribution.

The processor can be a component of a computer system and the computer system can be configured to control the operation of the device. A signal analyzer comprising the processor, such as a computer or an electrical circuit, can be employed for analyzing the photodetector signals, and determine the characteristic property of the sample.

The signal analyzer can be a computer which, optionally, controls other aspects of the system. The computer functions to perform the calculations necessary to detect the fringe movement and output the data on the user interface. Moreover, the computer can function to store and retrieve method files which automate the performance of an assay or analysis, provides data analysis tools to determine binding profiles, qualitative measurements, and quantitative measurements, as well as providing a means to calibrate the system for total gain and output based upon a reference sample.

The photodetector can be a camera, such as a CCD camera. The camera captures the image of the fringe pattern. A CCD camera can typically collect from 1 to sixty images per second. The image can be projected on a monitor for visual analysis. For example, the monitor can be calibrated and/or the operator can visually detect changes in the fringe pattern over time.

In an embodiment, the set of instructions when executed subject the fringe pattern to a Hamming window analysis prior to fitting the fringe pattern to a Gaussian distribution. The set of instructions can be a program code that when executed analyzes a series of fringe patterns.

In another embodiment, the processor is configured to execute a set of instructions that when executed compare fringe patterns at a first time to fringe patterns at a second time.

In some instances, the device has a pixel resolution and the comparison of fringe patterns at the first and second times has a sub-pixel resolution.

The device can be an interferometer that can comprise: a coherent light source; and a sample compartment for receiving the liquid, wherein the compartment is configured for analysis of the liquid therein by back-scatter interferometry when interrogated by coherent light beam from the coherent light source.

A back-scattering interferometer typically comprises an optical assembly and electronics to analyze an optical signal. The optical assembly can be mounted on an optical bench. Back-scattering interferometers are well known in the art. They are described, for example, in U.S. Pat. Nos. 5,325,170, 6,381,025; 6,809,828 and 7,130,060; International applications WO 2004/023115, WO 2006/047408 and WO 2009/039466; and U.S. patent publications U.S. 2006-0012800 and 2009-0185190.

The optical assembly comprises the following elements: First, a fluidic container having a compartment for holding a sample. A portion of the container in which the sample is contained functions as a sensing area or detection zone. Second, the optical assembly comprises a coherent light source positioned to direct a beam toward the sensing area, wherein the path of the beam defines an optical train and generates a back-scattering light pattern, also called an interference fringe pattern. Third, the optical assembly comprises a photodetector configured to detect the back-scattering light pattern. Typically, the instrument also will comprise a computer that converts the fringe pattern into a measure or indicator of refractive index. Optionally, the instrument comprises a temperature regulator that can maintain a stable temperature at least within the fluid during periods of measurement.

Several factors influence the generation of an interference pattern: Reflection, refraction and retardation (of the light beam). The coherent light beam should be large enough so that it passes across a non-flat surface from the container into the liquid. Accordingly, the compartment should comprise a curve or an edge (e.g., a corner) through which the light passes in order to generate a useful interference pattern.

### 1. Coherent Light Source

Examples of coherent light sources for use with the invention include, but are not limited to, a laser, for example a He/Ne laser, a vertical cavity surface emitting laser (VCSEL) laser, and a diode laser. The coherent light may be coupled to the site of measurement by known wave-guiding or diffractive optical techniques or may be conventionally directed to the measurement site by free space transmission. The coherent light is preferably a low power (for example, 3-15 mW) laser (for example, a He/Ne laser). As with any interferometric technique for chemical analysis, the devices and methods of the invention benefit from many of advantages lasers provide, including high spatial coherence, monochromaticity, and high photon flux. The beam can be directed directly to a sensing area on the fluidic chamber or to a mirror that is angled with respect to the plane of propagation of the laser beam, wherein the mirror can redirect the light onto the sensing area. In another embodiment, the coherent light is preferably generated by a solid state laser source such as a light emitting diode or vertical cavity surface emitting laser (VCSEL), for which requisite beam characteristics of monochromaticity and beam coherence is achieved. In an embodiment, the coherent light source generates an easy to align collimated laser beam that is incident on a sensing area of the container for generating the backscattered light.

A coherent light source can be directed onto a sensing area of the container chip such that the light beam is incident on the compartment to generate backscattered light through reflective and refractive interaction of the light beam, as well as retardation of the light beam, with the sensing area interface and the sample. The backscattered light comprises interference fringe patterns including a plurality of spaced light regions, e.g., bands or spots, whose positions shift in response to the refractive index of the sample. These spatial shifts represent phase shifts in the interference pattern. Positional shifts in the interference pattern can then be detected by a photodetector and computed using a processor, such as a PC. For example, one can examine shifts in the light regions, e.g., bands, relative to a baseline or a reference value. The device can provide a signal (for example, positional shifts in the light bands) that is proportional to abundance of the analyte.

In an embodiment, the coherent light source generates an easy to align collimated laser beam that is incident on a sensing area of the container for generating the backscattered light. The backscattered light comprises interference fringe patterns that result from the reflective and refractive interaction, as well as retardation of the incident laser beam with the sensing area walls and the sample in the sensing area. These fringe patterns include a plurality of light bands whose positions shift according to the refractive index of the sample, for example, due to the composition of the sample. The photodetector can detect the backscattered light fringe pattern and, in combination with algorithms and methods and systems described herein, convert it into signals that can be used to determine the refractive index (RI), or an RI related characteristic property, of the sample. For example, the RI of a sample with a certain concentration of analyte in the sample can be slightly different than the RI of a sample where the analyte is present in the sample in a different concentration. A signal analyzer, such as a computer or an electrical circuit, can be employed to analyze the photodetector signals and determine the characteristic property of the sample.

### 2. Detector

A photodetector can be configured and incorporated into a device of the invention to detect a back-scattering light pattern from a sensing area on a container. The photodetector can detect a back-scattering light pattern generated from a sample in the sensing area of the chip, wherein the pattern is based on the contents and/or composition of the sample. In an embodiment, qualitative and quantitative measurements are performed by forming molecular complexes; such as antibody antigen. Detection can be performed in a similar manner to an ELISA measurement, only a label on the antibody (in the case of an antigen based assay) is not used. In an embodiment, the photodetector detects a qualitative or quantitative value of an analyte in a liquid sample, for example, the amount of a specific antigen in a blood sample or host antibody titer towards a given antigen.

The photodetector can be one of any number of image sensing devices. It can can capture an image, either linear or two-dimensional, of the fringe pattern. The photodetector can include a bi-cell position sensor, a linear or two-dimensional array CCD or CMOS camera and laser beam analyzer assembly, a slit-photodetector assembly, an avalanche photodiode, or any other suitable photodetection device. The backscattered light comprises interference fringe patterns that result from the reflective, refractive, and retardation interaction of the incident laser beam with the walls of the sensing area and the sample. These fringe patterns include a plurality of light bands whose positions shift as the refractive index of the sample is varied, for example, through compositional changes. For example, a sample in which two components bind to each other can have a different refractive index than a sample in which the two components do not bind. In an embodiment, the photodetector detects the backscattered light and converts it into one or more intensity signals that vary as the positions of the light bands in the fringe patterns shift. For fringe profiling, the photodetector can be mounted above the chip at an approximately 45° angle thereto. Fringe profiling can also be accomplished by detecting the direct backscatter. In an embodiment, the fringes can be profiled in direct backscatter configuration and direct them onto the camera which is at 90° from the beam, in this way, the packaged device can remain small while maximizing the resolution for measuring a positional shift, for example, the effect of angular displacement.

The photodetector can be a camera, such as a CCD camera. The camera captures the image of the fringe pattern. A CCD camera can typically collect from one to sixty images per second. The image can be projected on a monitor for visual analysis. For example, the monitor can be calibrated and/or the operator can visually detect changes in the fringe pattern over time. Alternatively, the image can be subjected to a variety of mathematical algorithms to analyze the fringe pattern. Examples of algorithms used to analyze fringe pattern are Fourier transforms, Gaussian fit with or without hamming window and sinusoidal correction.

The intensity signals from the photodetector can be fed through an instrument control unit into a signal analyzer for fringe pattern analysis for determination of the refractive index or an RI related characteristic property of a sample in the sensing area of the microfluidic chip. The signal analyzer can be a computer (for example, a PC) or a dedicated electrical circuit. Preferably, the signal analyzer includes the programming or circuitry necessary to determine from the positional shift of the formed fringes, the RI or other characteristic properties of the sample to be determined, such as temperature or flow rate, for example.

### 3. Display and Analysis

The light collected by the photodetector, e.g., an image of a fringe pattern, can be displayed directly for visual analysis, for example by a monitor that displays a signal provided by the detector. Alternatively, the system can comprise a signal analyzer that converts data received from the photodetector into a value or values that are useful for further analysis.

The photodetector can detect the backscattered light fringe pattern and, in combination with computer algorithms, convert it into signals that can be used to determine a parameter of refractive index (RI), or an RI related characteristic property, of the sample. For example, the RI of a sample with a certain concentration of analyte in the sample can be slightly different than the RI of a sample where the analyte is present in the sample in a different concentration. A signal analyzer, such as a computer or an electrical circuit, can be employed to analyze the photodetector signals and determine the characteristic property of the sample. Positional shifts in the light bands relative to a baseline or a reference value can then be detected by a photodetector and computed using a processor, such as a PC. The device can provide a signal (for example, positional shifts in the light bands) that is proportional to abundance of the analyte. Preferably, the signal analyzer includes the programming or circuitry necessary to determine from the positional shift of the formed fringes, the RI or other characteristic properties of the sample to be determined, such as temperature or flow rate, for example. The parameter of refractive index can be, for example, the position of the bands on some scale of location. This position can be displayed as a number or as coordinate on a graph. For example, the coordinate on the Y axis can change over time on the X axis. The parameter can be quantitatively related to sample refractive index.

The signal analyzer can comprise a computer which, optionally, controls various aspects of the system. The computer functions to perform the calculations necessary to detect the fringe movement and output the data on the user interface. Moreover, the computer can function to store and retrieve method files that automate the performance of an assay or analysis, provide data analysis tools to determine binding profiles, qualitative measurements, and quantitative measurements, or provide a means to calibrate the system for total gain and output based upon a reference sample.

The computer can comprise memory configured to receive data about the back scattered light, such as images of the fringe pattern, captured from the photodetector. The computer also can comprise computer executable instructions in memory to manipulate the data, for example, methods according to this invention. The computer typically will comprise a processor for retrieving data and instructions from memory and for executing the instructions. The computer also can comprise input/output to receive data from the photodetector and to transmit the product of computer processing to peripherals such as display monitors.

The output of the computer can be displayed on a monitor in a form useful to the user. For example, the output can be displayed as a line on a graph, wherein the position of the line indicates the relative position of the fringe pattern. Alternatively, the output could be a binary indicator that indicates whether the position of the fringe pattern has shifted over some given period of time, or before and after an event (e.g., introduction of an analyte).

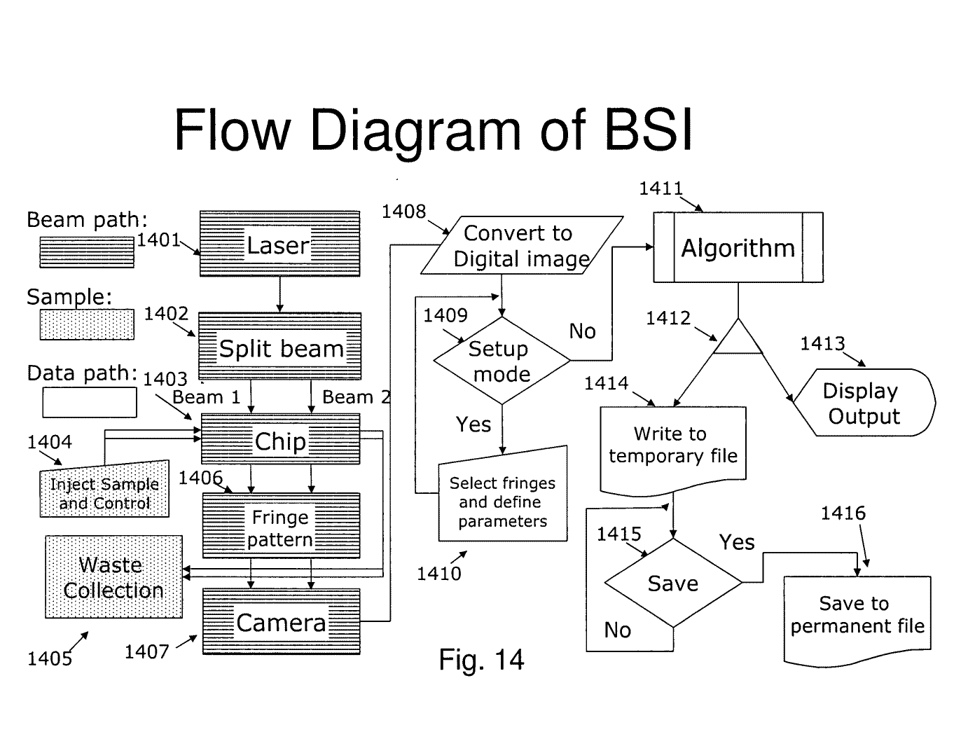

FIG. 14 depicts a flow diagram of a BSI system. A laser 1401 produces a beam that passes through a beam splitter 1402 to create two beams. A beam splitter is optional but useful for comparing first and second samples. These two beams impinge onto a chip 1403. The two-channel chip allows for the injection of samples and controls 1404. The liquid that is injected passes through the chip 1403 and then is collected as waste 1405. In an exemplary embodiment, the chip has two channels for the injection of samples and controls 1404. The interaction of the beams and the channels creates fringe patterns 1406. These two fringe patterns 1406 are directed onto a camera 1407. The data acquired from the camera 1407 is converted into a digital image 1408. Initially, the program is started in setup mode 1409, which allows the user to select the fringes to be analyzed and define the parameters of the analysis 1410. Once setup mode 1409 is turned off, the digital image 1408 is passed to an algorithm 1411 that calculates shifts in the fringe pattern 1406. This output is split 1412 to a real time output display 1413 and is also written to a temporary file 1414. At any time the user can save the data 1415, which then writes the data to a permanent file 1416.

BSI can detect changes in refractive index in real time. Therefore, it is a useful tool for measuring binding assays in real time. Also, BSI can be used to compare two samples for differences in refractive index, thereby indicating differences between the contents of the two samples.

Interferometric detection is amenable to high throughput assay methods, as the molecules, particles or cells do not require labeling with other reagents, such as fluorescent tags, thus requiring less processing of individual samples. The presence of the mass of the immobilized target or a signal due to a binding pair in solution, in embodiments where no binding moiety is immobilized, is detected directly as a function of interferometric intensity and is robust under laser interrogation. The resulting signal is not susceptible to the photobleaching and loss of precision under long or repeated laser exposure of fluorescently labeled targets. Interferometric detection is a sensitive method of detection. Femtomolar levels of numbers of molecules can be detected and low picomolar (10-12) concentrations of target molecules can be detected.

An analyte in a sample can be detected in a sample in a number of ways. First, the interference patterns of a sample and a matched control can be compared. For example, a control sample should contain the same reagents and be contained in a container of the same dimensions as the test sample, but exclude the analyte. In this case, an important element that contributes to differences in the interference patterns will be differences in interaction between the analyte and the reagents in the two samples. For example, in a binding assay, differences between the concentration of an analyte between the two samples will be result in differences in amount of binding with a binding reagent, which, in turn, will result in differences in the interference pattern produced.

However, control and test samples may not be evenly matched. For example, a control plasma sample and a test plasma sample may have differences in various molecules that will result in differences in refractive index even if the concentrations of the analytes are the same. If analyte concentration differences contribute most to differences in refractive index, then this need not be an issue. However, these differences can be addressed in various ways. For example, a kit can provide reagents to construct a standard curve. Measuring results on the test sample against the standard curve provides an indication of the quantity of the analyte in the sample. Comparison of two samples, one with the reagents and one without, provides a measure of what contribution the presence of analytes make to changes in refractive index. A test sample can be divided between two containers, one with reagents and one without, for this purpose. Moreover, for heterogeneous assays which employ sample vessels for which capture molecules have been selectively deposited in given probe regions, sample and experimental measurements can be conveniently performed within a single tube. In this approach, sample of interest is selectively captured using capture molecules prudently localized within the probed region of the sample beam, while the reference beam interrogates a different region of the same vessel, which is devoid of extracted analyte. In this approach sample and reference measurements are performed on the sample matrix solution, variations in biological matrix, such as serological composition, ionic strength, and other bulk propertied can be compensated enhancing the signal to background.

The system can be used to determine the on- and off-kinetics of binding with a flowing system. In the flowing system, one molecule can be attached to the surface with chemistry. A running buffer is then flowed over the activated surface. Once the signal is stable, a second molecule that binds to the first is flown thought the system in increasing concentrations. When the sample interacts with the surface, there is an increase in signal until equilibrium is reached. When the running buffer is flowed back through, the bound molecules disassociate and the signal decreases and then equilibrates on the running buffer. For the reaction of the two molecules, an increase in signal is observed and then equilibrates. For this part of the curve, a ‘one phase exponential association’ equation is used [Y=Ymax*(1−exp (−K*X))] where K is the K observed. For the dissociation of the two molecules, a decrease in signal is observed until an equilibrium is reached. For this part of the curve, a ‘one phase exponential decay’ equation is used [Y=Span*exp (−K*X)+Plateau], where the K is the K off. The K on value is calculated by subtracting the K off from the K observed then dividing the value by the concentration of the binding ligand {Kon=(Kobs−Koff)/[ligand]}. The K_{D} value is collected by dividing the K off by the K on [K_{D}=Koff/Kon]. These equations assume one to one binding and that the concentration of one of the molecules is unchanged during the reaction. This is accomplished by the use of the flow as there is a constant amount of the same concentration being introduced into the channel.

### 4. Instrument with Continuous Injection

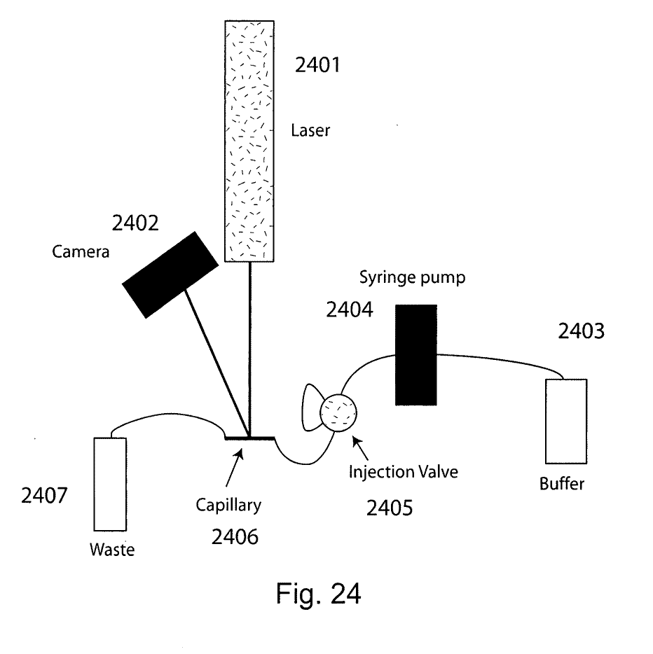

One version of the instrument allows for sample analysis in flowing streams. (See FIG. 24.) The basics of the instrumentation are the same; a coherent light source 2401 is directed onto a fluidic channel 2406, which produces a fringe pattern that is captured by a camera 2402.

A syringe pump (Cavro) 2404 is utilized with an injection valve to create a flowing system. The syringe pump pulls in a volume of liquid from a container 2403 which is then dispensed at desired flow rates. These rates can range from 10 microliters per minute to 0.5 microliters per minute, e.g., approximately 2.5 μL/min. The fluid passes through an injection loop and then the detection zone of the instrument. This provides a continuous flow of running buffer in the system. The injection loop can have a volume of 20 μL, that can be changed based on the size and length of tubing used. The injection valve 2405 allows the injection of different samples without disrupting the flow of the system, as when in the load position the valve circumvents the loop allowing the running buffer to continuously flow. A sample is injected using a 250 μl analytical glass syringe into the loop. When the valve is switched to the inject position, the running buffer flows through the loop, pushing the injected sample into the detection zone. Thus the flow is never interrupted, aside from during the pump refill cycle.

The injected samples are pushed into the BSI instrument, which has a holder, which equilibrates the temperature of the fluid to a set point (typically 25° C.) by wrapping the capillary around a metal bobbin that is temperature controlled. The fluid is then pushed into the detection zone.

The detection zone is a small piece of capillary that the laser strikes. The small section of the capillary allows for surface chemistry to be performed on a large section and then cut into smaller sections for a heterogeneous experiment. After the fluid is analyzed, a waste tube is used to direct the sample into a waste container 2407.

### 5. The Container

The container used in this invention is adapted for use in back scattering interferometry. The container is adapted to generate a backscatter fringe pattern when filled with liquid and interrogated with a focused or unfocused coherent light source, such as a laser beam. Factors that influence the ability to create such a pattern include the relative refractive indices of the substrate that forms the container and the liquid within, as well as the shape of compartment in which the liquid is contained and the light source strikes.

The container can take the shape of a chip (e.g., a microchip). As in known in the art, chips can accommodate a plurality of channels or other features due to having one very thin dimension compared with their other dimensions. The container also can take the shape of a tube, such as a microcapillary tube.

### i. Container Material

The container should be made of a material that has a different (e.g., higher) refractive index than the sample inside. The container can be formed of any suitable optically transmissive material, such as glass, quartz, borosilicate, silica (e.g., fused silica) or a polymeric material, e.g., a plastic such polystyrene, polysulfone, polyetherimide, polyethersulfone, polysiloxane, polyester, polycarbonate, polyether, polyacrylate, polymethacrylate, cellulose, nitrocellulose, a perfluorinated polymer, polyurethane, polyethylene, polyamide, polyolefin, polypropylene or nylon.

### ii. Compartment Shape And Size

The container will have an internal compartment that can hold the sample. Typically, the compartment will take the shape of a bore. The bore may have a curved cross section that is, for example, circular, substantially circular, hemicircular, rectangular or elliptical. Backscatter fringe patterns are easily produced when the substrate includes a compartment having curved or angular walls through which the light passes to reach the sample.

In certain embodiments, the compartment takes a long, thin shape, such as a channel, column, cylinder or tube.

The container also is adapted to receive a liquid sample. In certain embodiments, the container is adapted to function as the collection unit of the sample from its primary source, e.g., a subject organism. For example, the container can comprise a channel or tube that opens at two ends of the container. For example, the container can be a capillary tube or a hematocrit tube, or a chip comprising a channel that opens at different sides of the chip.

The container can take the shape of a capillary tube or microhematotcrit tube. The tube can be, for example, approximately 75 mm long, with fire-polished ends that can easily be sealed if desired. Tube can be coded with a red band to designate heparin coating. It can contain at least 2 U.S.P. units of cation-free ammonium heparin. It can have an I.D. is 1.1 to 1.2 min with a wall of 0.2 mm±0.02. The volume of the compartment can be between 100 nanoliters and 1000 microliters (10 milliliters), between 1 microliter and 1 milliliter, between 10 microliters and 1 milliliter or between 50 microliters and 250 microliters. Furthermore the tube can have dimensions as follows: Outside diameter 0.75 to 2.0 mm, inside diameter from 0.05 to 1.5 mm.

In some embodiments, the channel is a microfluidic channel. Microfluidic channels generally have a cross sectional area of less than 1 mm². In other embodiments, the channel has cross sectional area of about of about 0.01 mm², about 0.02 mm², about 0.03 mm², about 0.04 mm², about 0.05 mm², 0.06 mm², about 0.07 mm², about 0.08 mm², about 0.09 mm², about 0.1 mm², about 0.2 mm², about 0.3 mm², about 0.4 mm², about 0.5 mm², about 0.6 mm², about 0.7 mm², about 0.8 mm², about 0.9 mm², or about 1.0 mm².

In other embodiments the channel has a diameter no greater than any of: about 1.0×10⁴ μm, about 9×10³ μm, about 8×10³ μm, about 7×10³ μm, about 6×10³ μm, about 5×10³ μm, about 4×10³ μm, about 3×10³ μm, about 2×10³ μm, about 1×10³ μm, about 9×10² μm, about 8×10² μm, about 7×10² μm, about 6×10² μm, about 5×10² μm, about 4×10² μm, about 3×10² μm, about 2×10² μm, about 1×10² μm, about 9×10 μm, about 8×10 μm, about 7×10 μm, about 6×10 μm, about 5×10 μm, about 4×10 μm, about 3×10 μm, about 2×10 μm, about 1×1 μm, about 9 μm, about 8 μm, about 7 μm, about 6 μm, about 5 μm, about 4 μm, about 3 μm, about 2 μm, about 1 μm, about 0.9 μm, about 0.8 μm, about 0.7 μm, about 0.6 μm, about 0.5 μm, about 0.4 μm, about 0.3 μm, about 0.2 μm, or about 0.1 μm. In other embodiments the channel has a diameter no greater than 500 μm.

In certain embodiments the analyte is detected as a result of its binding to a binding agent. In this case, the binding agent for an analyte in a sample that one is testing for can be immobilized on the wall of the compartment (heterogeneous assay) or allowed to remain free in solution after the sample is added (homogeneous assay). Binding partners include, for example, antibodies and antibody-like molecules, receptors, nucleic acids (e.g., oligonucleotides). In another embodiment, the agent can be an enzyme or enzyme complex (mixture) which catalyzes an enzymatic reaction which can degrade sample components such as cells, cell fragments, and/or biomolecules. In another embodiment the agent could be an enzyme or enzyme complex (mixture) which catalyzes the creation of new biomolecules arising from the fusion of biomolecular species (such as a ligase) or replication—amplification of biomolecular species, as is the case in polymerase chain reactions.

Moreover, the surfaces of the sample container could be coated with a material to minimize unwanted interactions with the walls of the container. Such surfaces would include polymeric coatings, such as dextran, Teflon, polyethylene glycol, etc. Furthermore, the surfaces of the container could be coated with biospecific reagents for selective capture of target analytes or selective enzymatic modification of target analytes as described above.

### 6. Container Mounting/Temperature Regulation

The device of this invention typically comprises a mounting adapted to receive the container and position it for interrogation by the coherent light source. The mounting can be removable from the frame of the device. The mounting can be attached to an optical bench that comprises other components of the optical system. The mounting can comprise a fastener to fasten the container to the mounting. If the container is a tube, the mounting can comprise, for example, a clip or set of clips, a surface with an indentation adapted to receive the tube, in which it can rest, an adhesive material, or a holder in which the container is inserted and held, e.g., a cylinder in which a tube is slid within and retained, a flat mounting stage on which a chip is locked into position. In certain embodiments the mount is in thermal contact with a temperature control assembly such as a Peltier device to insure homogeneous control of temperature as required to perform high sensitivity BSI measurements (+/−1-5 millidegree C.). See, for example, U.S. patent publication 2009-0185190.

A container of the invention can be adapted and configured to fit snugly within a holder. The container can be held in place by a positioner, such as a metal plate with tightening screws. The container can be manually inserted into the holder or cartridge. In an embodiment, the container is disposable while the holder can be used for numerous different chips with a device of the invention. A holder retention mechanism can be used to firmly hold the chip in the holder along the axis of the mechanism. The container and/or the thermal subsystem can be affixed to a translation stage that allows adjustment of the chip relative to the laser beam. For example, the container can be tilted slightly (for example, approximately 7°) so that the backscattered light from the sensing area of the container can be directed onto the photodetector.

In experiments that involve comparing the interference pattern between two samples (e.g., a test and control sample), the samples can be measured simultaneously or in sequence. In simultaneous measurements the two samples can be loaded onto the interferometer and a beam splitter can split the laser beam and direct it to each of the two samples. Alternatively, the beam can be made wide enough so that a single beam covers both fluid compartments. In one embodiment, the first and second samples are comprised in different containers, e.g., tubes, and one tube is tilted or rotated, e.g., 3° to 7° with respect to the other tube. This results in the interference signal from each container being directed to different parts of the detector so that they are distinguishable.

In another embodiment, the first and second samples are located within a single tube, where the first sample represents a region of the sample container that contains a selectively deposited binding molecule for extraction and subsequent analysis of a target of interest, and where the second or reference sample represents a region of the sample container that is free of binding molecule, or moreover is coated with a specific passivating agent to minimizing unwanted non-specific binding of the target of interest.

Sample can be introduced into the container by any method known. For example, the sample can be introduced manually using a syringe, e.g., manual pipetter. Also, sample can be introduced into the container using a fluidics robot, such as any commercially available robot, e.g., from Beckman or Tecan.

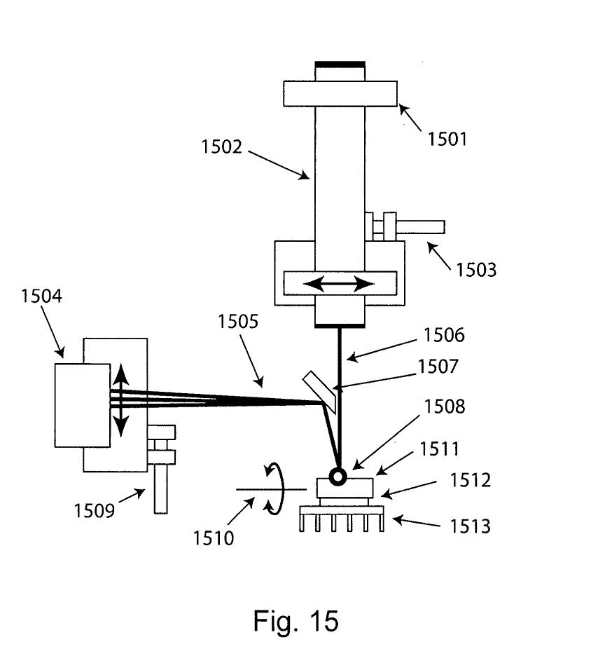

FIG. 15 depicts an exemplary full BSI device configured for analyzing a blood sample. The clamp 1501 holds the laser 1502 in place. The translation 1503 moves the laser 1502 to the left and right to allow alignment. The beam 1506 hits the tube 1508, wherein the tube may contain the blood sample, and creates a fringe pattern 1505. A mirror 1507 is used to direct the fringe pattern 1505 onto camera 1504. The translation 1509 allows for the alignment of the camera 1504. The tube 1508 sits in a holder 1511 that is temperature controlled by a thermal electric cooler 1512 and a heat sink 1513 is used to dissipate the temperature difference. The angle adjustment 1510 is used to align the tube 1508.

### III. Liquid Sample

The liquid as described herein can be any liquid sample. Typically the sample will be a heterogeneous sample that includes a solvent, soluble or suspended materials, and insoluble materials. In particular, the fluid can be a biological sample, for example, saliva, blood, urine, lymphatic fluid, prostatic or seminal fluid, milk, lymph, cerebrospinal fluid, synovial fluid, vitreous humor, aqueous humor, mucus, vaginal fluid or semen. The liquid also can be derived from biological materials, such as cell extracts, cell culture media, fractionated samples, or the like. In one embodiment, the sample is blood or a blood fraction, such as serum or plasma. Blood is an aqueous solution. It contains soluble or suspended materials including electrolytes and biomolecules such as polypeptides, polynucleotides, polysaccharides, lipids, proteins, glucose, clotting factors, mineral ions, hormones, steroidal compounds, etc. It also includes insoluble materials such as blood cells, cellular debris, and clots. Plasma is blood from which the cells have been removed. Serum is blood plasma without fibrinogen or the other clotting factors. As shall be discussed, the sample can be collected in the same container to be used in the back scattering interferometry analysis, and the insoluble materials can be separated therein.

In certain embodiments an analyte being detected by a method or system herein can be detected as a result of its binding to a binding agent. In this case, the binding agent for an analyte in a sample that one is testing for can be immobilized on the wall of the compartment (heterogeneous assay) or allowed to remain free in solution after the sample is added (homogenous assay). Binding partners include, for example, antibodies and antibody-like molecules, receptors, nucleic acids (e.g., oligonucleotides). In another embodiment, the reagent can be an enzyme or enzyme complex (mixture) which catalyzes an enzymatic reaction which can degrade sample components such as cells, cell fragments, and/or biomolecules. In another embodiment the reagent could be an enzyme or enzyme complex (mixture) which catalyzes the creation of new biomolecules arising from the fusion of biomolecular species (such as a ligase) or replication—amplification of biomolecular species, as is the case in polymerase chain reactions. Moreover, the surfaces of the sample container could be coated with a material to minimize unwanted interactions with the walls of the container. Such surfaces would include polymeric coatings, such as dextran, Teflon, polyethylene glycol, etc. Furthermore, the surfaces of the container could be coated with biospecific reagents for selective capture of target analytes or selective enzymatic modification of target analytes as described above.

### IV. Liquid Sample Analysis

BSI can detect changes in refractive index in real time. Therefore, it is a useful tool for measuring biding assays in real time. Also, BSI can be used to compare two samples for differences in refractive index, thereby indicating differences between the contents of the two samples.

An analyte in a sample can be detected in a sample in a number of ways. First, the interference patterns of a sample and a matched control can be compared. For example, a control sample should contain the same reagents and be contained in a container of the same dimensions as the test sample. In this case, an important element that contributes to differences in the interference patterns will be differences in interaction between the analyte and the reagents in the two samples. For example, in a binding assay, differences between the concentration of an analyte between the two samples will be result in differences in amount of binding with a binding reagent, which, in turn, will result in differences in the interference pattern produced. However, control and test samples may not be evenly matched. For example, a control plasma sample and a test plasma sample may have differences in various molecules that will result in differences in refractive index even if the concentration of the analytes are the same. If analyte concentration differences contribute most to differences in refractive index, then this need not be an issue. However, these differences can be addressed in various ways. For example, a kit can provide reagents to construct a standard curve. Measuring results on the test sample against the standard curve provides an indication of the quantity of the analyte in the sample. Comparison of two samples, one with the reagents and one without, provides a measure of what contribution the presence of analytes make to changes in refractive index. A test sample can be divided between two containers, one with reagents and one without, for this purpose.

In an embodiment, a method provides analyzing a structural or conformational change of a molecule by monitoring the change in refractive index of a liquid. The temperature of a liquid can be measured from the change in refractive index of the liquid.

Several kinds of assays to detect analytes are contemplated by this invention. They include, without limitation, (1) homogenous or heterogeneous binding assays to detect and/or quantify an analyte and (2) enzymatic assays to detect and/or quantify an analyte.

A variety of assays are contemplated by this invention. These include, for example, reactive titers, infectious diseases, drugs of abuse, sepsis, oxygen monitoring, detection of biomarkers of disease (e.g., proteins) molecular biological assays such as SNP analysis, STTR analysis, hybridization analysis for genotyping or gene expression, PCR analysis, allelotyping, haplotyping, as well as monitoring of enzymatic reactions. In another embodiment, a method can comprise analyzing a label-free hybridization reaction in a liquid by analyzing the change in refractive index of the liquid.

Alternatively, a difference in titer of certain analytes compared with a control also can be detected by BSI.

A first and second biochemical species and whether the first and second biochemical species interact with one another can be monitored by monitoring the change in refractive index of the liquid. In some instances, the first and second biochemical species are selected from the group comprising complimentary strands of DNA, complimentary proteins and antibody-antigen pairs.

Methods herein can provide monitoring of whether a ligand in a liquid binds with one or more receptors by monitoring the change in refractive index of the liquid.

An analyte can be detected in a sample through a binding assay with a binding reagent. A binding reagent can specifically bind to the target analyte. Any analyte that has a binding partner can be detected by including the binding partner in device. Binding between the binding partner and the analyte can result in a change in refractive index that can be detected by BSI. For example, the analyte could be a component of an infectious agent. Alternatively, it could be a biomarker for a disease, such as cancer. Any molecule that can be captured can be detected by BSI.

In a homogenous assay, the binding partner is free in the compartment and is taken into solution upon contact with the sample. In a heterogenous assay, the binding reagent is immobilized to the wall of the compartment. Methods for immobilizing a binding reagent to a wall of a compartment are well known in the art. For example, for any surface with available reactive groups, such as glass, the reactive groups can be coupled to a silane containing moiety by using a reactive compound such as amino-propryl-triethoxy silane or mercapto-amino-propyl-triexthoxy silane. A bifunctional coupling agent, can then be employed to covalently attach to the silane layer and subsequently couple its other end to a target biomolecule, tethering that biomolecule to the surface. Exemplary bifunctionial linkers include but are not limited to, succinimidoalkylbenzaldehydes, dimethyl dithiobispropionimidate, N-[gamma-maleimidobutyryloxy]succimide ester, and N-[gamma-malaeimidobutyryloxy]sulfosuccinimide ester. Coupling to the desired target biomolecule is achieved via reaction between the terminal group of the bifunctionial linker and a companion reactive group of the biomolecule such as an amine, a hydroxide, a sulfhydryl, a carboxyl, and so on.

Analytes in the blood that can be detected by binding assays include, for example, pathogneumonic antibodies indicative of infectious disease, autoimmune disease, or cancer; surface antigens or liberated proteins from infectious elements such as parasites, bacteria, viruses, and molds; surface antigens or liberated proteins from host neoplasms; specific host response proteins to tissue damage, necrosis, apoptosis; specific host proteins spawned as the result of general inflammatory response damage as associated with autoimmune disease, rheumatoid arthritis, osteoarthritis, cancer, ethanol toxicity, therapeutic agent toxicity, drug abuse, and/or infectious disease; liberated proteins associated with ischemia and tissue damage as in cardiomyopathies, drugs of abuse and their metabolites, therapeutics and their metabolites; and so on.

Binding agents include, for example, aptamers, thioaptamers, double-stranded DNA sequence, peptides and polypeptides, ligands and fragments of ligands, receptors and fragments of receptors, antibodies, fragments of antibodies (e.g., a single chain antibody, an Fab, Fab′ F(ab′) 2 fragment) or hybrid antibodies and polynucleotides. The binding reagent can also be a member of other types of binding pairs such as biotin-avidin; apo-protein-cofactor; lectin-saccharide (or polysaccharide); lectin-cell; IgG antibody Fc portion with protein A or protein G; enzyme-enzyme substrate; sense-antisense nucleic acid sequences such as DNA:DNA, RNA:RNA; DNA:RNA, DNA fragments or other nucleic acid sequences; enzyme-enzyme inhibitor; receptor-ligand; protein-protein receptor; protein subunit-protein subunit; lipid-lipid.

Enzymatic assays typically are time course assays. In such assays, one measures differences in refractive index in a sample over time. Differences indicate the action of the enzyme on the analyte. One example of an enzymatic assay is enzymolysis.

In one assay, the assay is provided with substrates for enzymes in the sample. For example, typical enzymes detected in the blood of clinical interest include alkaline phosphatase, amino transferases (e.g., aspartate transaminase, alanine transaminase, gamma glutamyl transferase), lactate dehydrogenase, and creatinine kinase.

In this type of assay, the container is provided with a substrate that is cleaved by a serum protease, such as alkaline phosphatase activity upon a phosphopeptide, phosphoprotein, phosphorylated nucleic acid or phosphorylated polynucleic acid. In this type of assay a general assessment of serological enzymatic activity against a number of serum proteases could be assessed as part of a diagnostic regimen.

Other enzymatic assays are used to detect the presence of a nucleotide sequence in DNA. For example, in PCR, primers, nucleotides and a polymerase are used to amplify a sequence within a DNA sample. This typically involves thermal cycling, in which each cycle amplifies the target sequence. Measurements can be taken after each cycle. Again, changes in refractive index result from polymerization reactions which, in turn indicate the presence of the target sequence. Other methods of DNA sequence detection are known in the art. One of these is detection by ligation, in which probes that hybridize to adjacent sequences are provided with a ligase. If the target sequence is present, the probes will hybridize adjacent to one another and the ligase will ligate the two probes. This change can then be detected.

### Example 1

For the surface bound experiments, the one of the reactants is bound to the surface of the chip or capillary. A solution containing the other reactant is flowed over the activated surface. As the reactants bind an increase in signal is observed (K_{ob}). The buffer without the second reactant is then flowed over the surface. The bound reactants then come apart and a decrease in signal is observed (K_{off}). In this experimental setup, a measurement of the solution that contains the second reactant is flowed over a capillary without surface activation and is used to measure the signal from the bulk RI from the reactant, which is then removed from the assay data. Kₒₙ and K_{D} can then be calculated. These parameters indicate how strongly two reactants bind, which is important in many applications such as drug discovery. Table 1 indicates some of the properties of the example.

TABLE 1
Kₒₙ/K_{off}/K_{D} Measurements.

| Variable | Units | Comment |
|---|---|---|
| kon | Molar-1 min-1 | (Kobs − Koff)/[ligand]. |
| kob | min-1 | The value of K determined by fitting |
| | | an exponential association equation to |
| | | your data. |
| koff | min-1 | The dissociation rate constant. |
| | | Determined by fitting an exponential |
| | | dissociation equation. |
| [ligand] | Molar | Set by the experimenter. Assumed to |
| | | be constant during the experiment |
| | | (only a small fraction binds). |

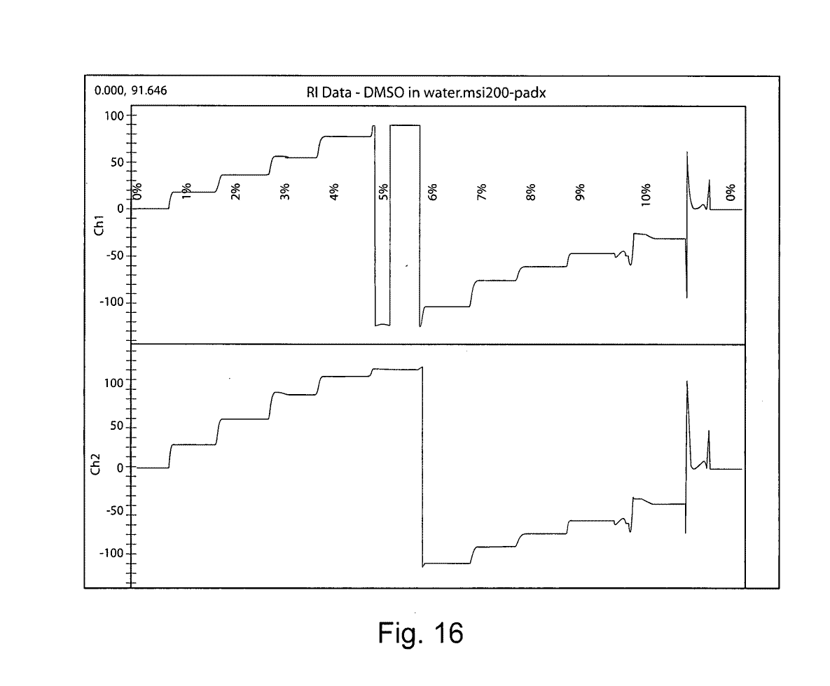

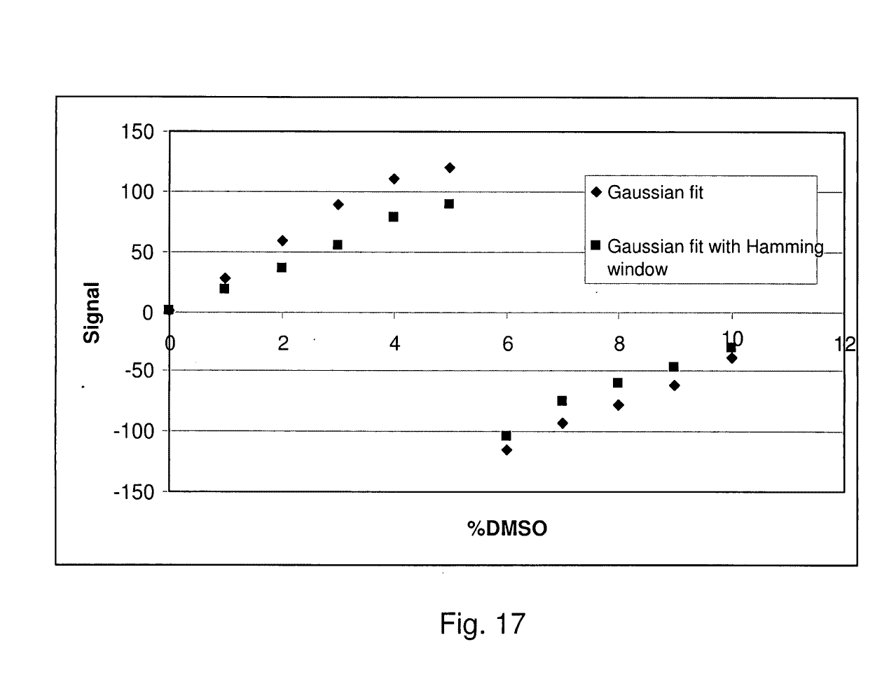

In an example, the methods and systems herein utilizing an analysis of a positional shift of a fringe pattern where conducted in an experiment. The experimental data shown in FIG. 16 is from an experiment where different percent DMSO in water was introduced into the system. As shown in FIG. 16 there is a large pixel shift (over 100 for Gaussian fit), then a sudden drop to a negative number, and then continued increase. This shows a linear response over a large range. The selected data shows the following results in FIG. 17.

However, if a constant value is added to the 6-10% DMSO solutions, then it is possible to make a linear graph, despite the fringe wrapping as shown in FIG. 17. The value to add can be calculated by the size of the drop in the between the 5% and 6% DMSO.

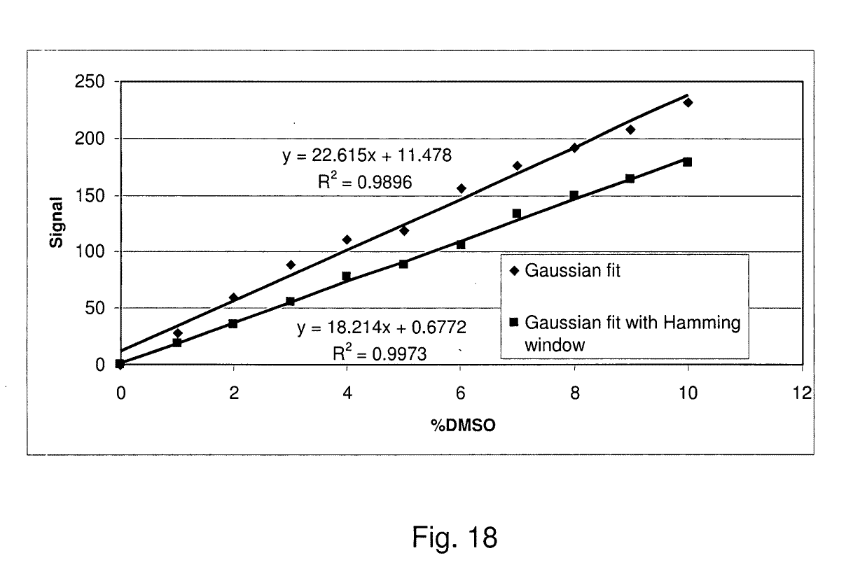

In this example, the data demonstrated that the Gaussian fit with the Hamming window produces a lower signal, but the line fit is superior as shown in FIG. 18. The Gaussian fit data demonstrates the 5% DMSO point is low and then the 6% DMSO point is high compared to the line fit.

### Example 2

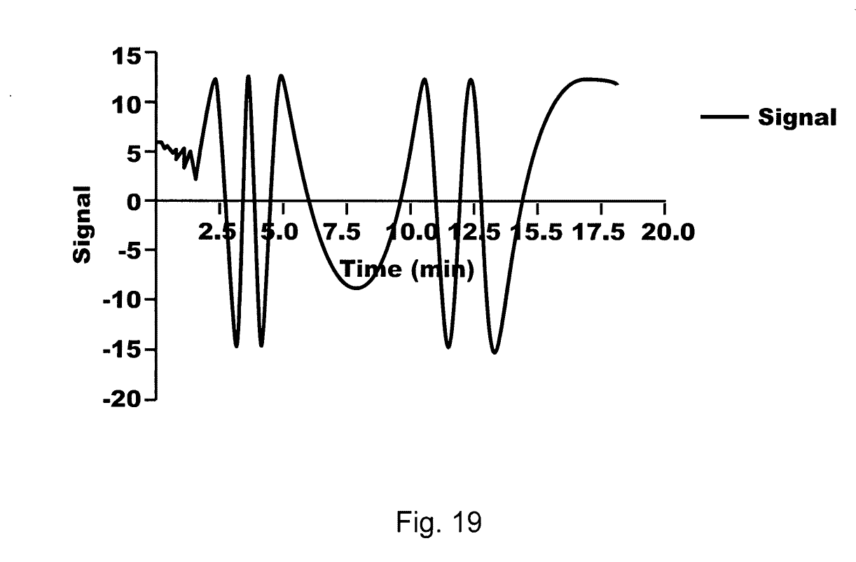

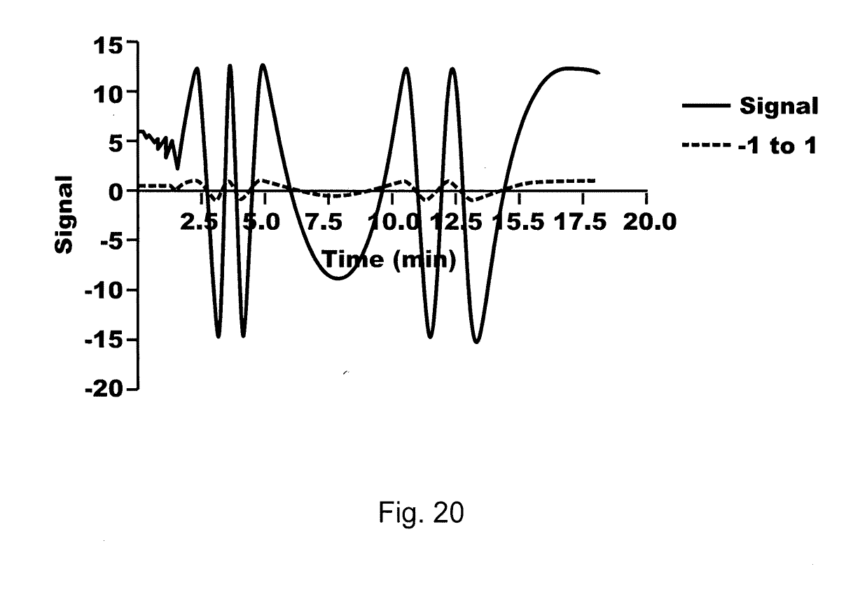

FIG. 19 illustrates data generated by back-scattering interferometry. At around 7.5 min, there is a change in direction. Since the values have to be −1 and 1, the minimum and maximum values are located. The data is then normalized by subtracting the minimum and maximum values and dividing by 2. Every signal value can be divided by this number. The difference of 1 from the new maximum can be taken (for example, 1-1.082=−0.082) and this value can be added to all the new signal data to center around the zero point. This step is illustrated in FIG. 20.

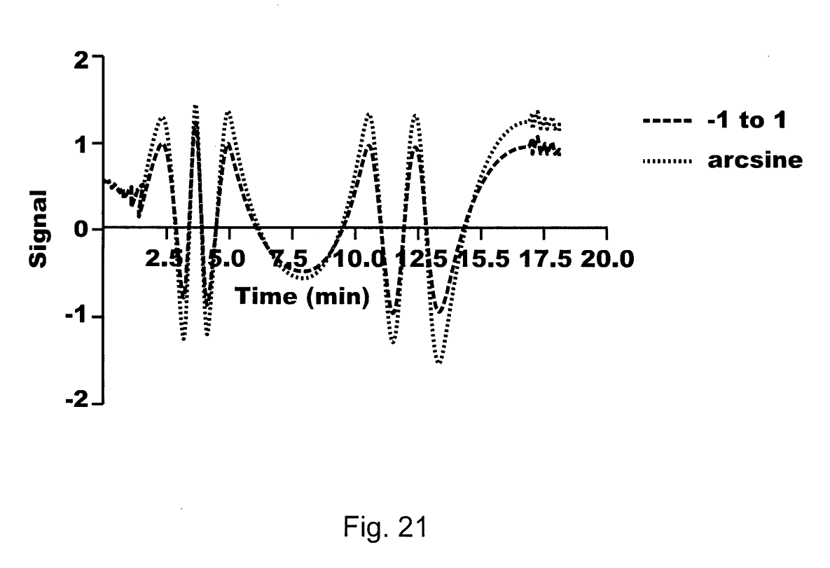

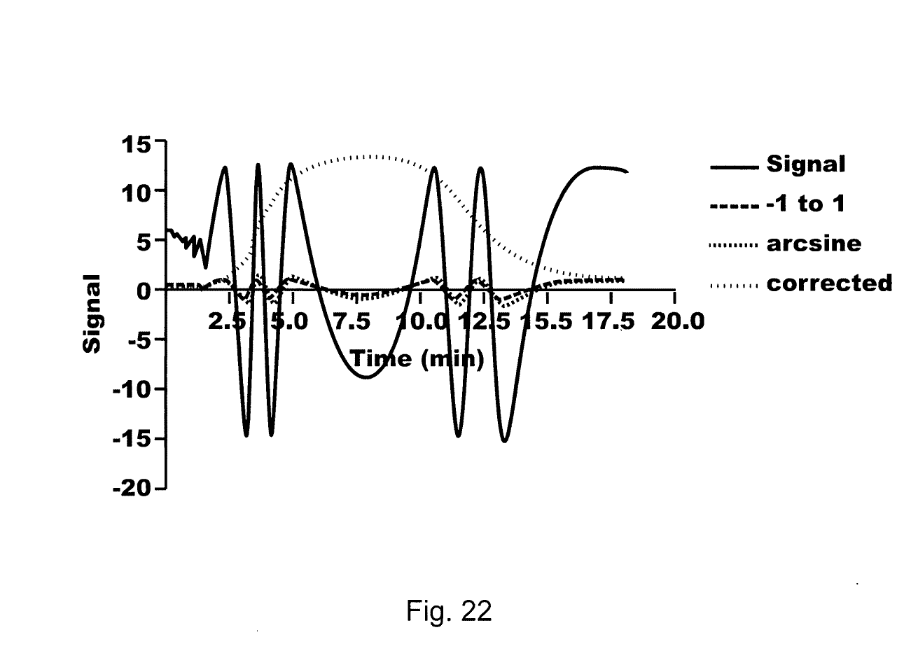

FIG. 21 illustrates the arcsine of the normalized function from FIG. 19. The values are corrected as described previously herein. Once the data changes directions, the sinusoidal data correction equations described earlier allow the curve to go down as shown in FIG. 22. The selection of regions can be completed by looking for local maximum or minimum in the arcsine data. By performing calculations in this manner, the noise in the signal is not lost, but the data is flipped in the correct direction. The change in direction of the fringe pattern is usually obvious in the data (in this example, around 7.5 min). The corrected values as shown in FIG. 22 have the right shape, however are greatly reduced in signal strength.

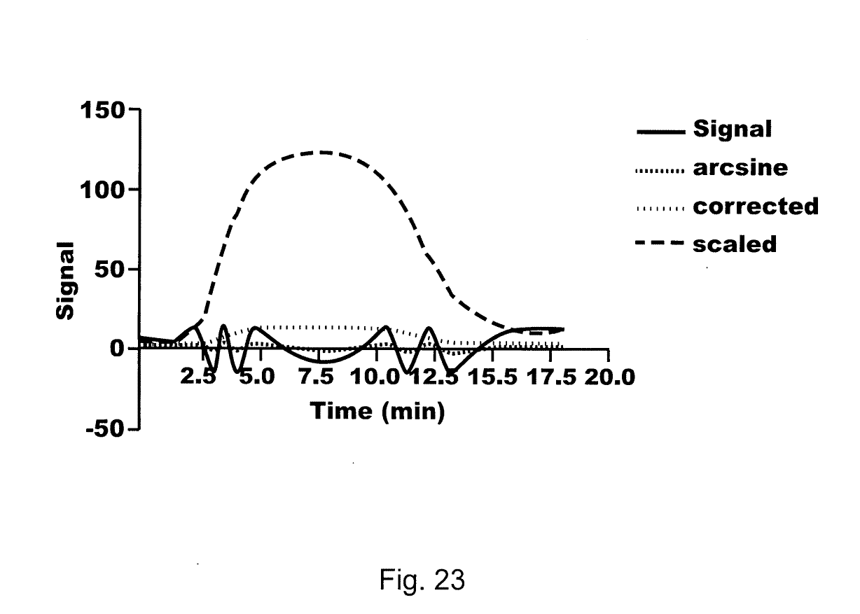

The same scaling factor that was used to reduce the signal to −1 to 1 in step 1 is used to scale the corrected data as demonstrated in FIG. 23. In this example, the end data collected for a single experiment must all be treated in the same way to ensure accuracy.

The data shown in this example demonstrates over two full cycles in the fringe pattern from back-scattering interferometry (both in the positive direction and then returning near original location) without any fringe counting necessary.

This experiment was the introduction of a sample into a capillary with an activated surface. After the bulk RI change is removed, the K_{obs} is obtained from the first half of the graph and then the K_{off} from the second half.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### REFERENCES

Bornhop, Darryl J.; J. C. Latham, Amanda Kussrow, D. A. Markov, Richard D. Jones and Henrik S. Sørensen, “Free-Solution, Label-Free Molecular Interactions Studied by Back-scattering Interferometry”, Science 21 Sep. 2007: Vol. 317. no. 5845, pp. 1732-1736
Dendane et al., Lab Chip 2008, 8:2161
Heideman, R. G. & Lambeck, P. V. Remote opto-chemical sensing with extreme sensitivity: design, fabrication and performance of a pigtailed integrated optical phase-modulated Mach-Zehnder interferometer system. Sensors and Actuators B 61, 100-127 (1999)
Markov D A, Swinney K, Bornhop D J: Label-free molecular interaction determinations with nanoscale interferometry. J Am Chem Soc 2004; 126:16659-16664.
Swinney K, Markov D, Bornhop D J: Chip-scale universal detection based on backscatter interferometry. Anal Chem 2000; 72:2690-2695.
Sorensen, H. S.; Larsen, N. B.; Latham, J. C.; Bornhop, D. J.; Andersen, P. E., “Highly sensitive biosensing based on interference from light scattering in capillary tubes”, Applied Physics Letters 89(15) 2006.
Ymeti, A. et al. Realization of a multichannel integrated Young interferometer chemical sensor. Applied Optics 42, 5649-5660 (2003)
U.S. Pat. No. 5,325,170
Bornhop D J: U.S. Pat. No. 6,381,025: Inteferometric Detection System and Method. In USPTO (ed): USPTO. USA, Texas Tech University, 2002:1-7.
Bornhop D J: U.S. Pat. No. 6,809,828: Universal Detector for Biological and Chemical Separation or Assays Using Plastic Microfluidic Devices. In USPTO (ed): USPTO. USA, Texas Tech University, 2004.
U.S. Pat. No. 6,559,947
Bornhop D J: U.S. Pat. No. 7,130,060: Refractive Index Determination by Micro Interferometric Reflection Detection. In USPTO (ed): USPTO. USA, Texas Tech University, University of Denmark, Riso National Laboratory, 2006.
International application WO 2004/023115
International application WO 2006/047408
International application WO 2009/039466
U.S. patent publication 2006-0012800
U.S. patent publication 2009-0185190

What is claimed is:

1. A method for determining a change in refractive index of a liquid comprising:
a. fitting a Gaussian distribution to a cross correlation from a pattern from interferometric analysis of a liquid at a first and second time;
b. identifying a positional shift of the pattern by comparing a selected value of the Gaussian distributions of the pattern at the first and second times; and
c. deriving a change in refractive index of the liquid from the positional shift.

2. The method of claim 1, further comprising, before fitting the pattern, capturing a fringe pattern generated from a sample at two different times with a photodetector and optionally performing a function on the pattern.

3. The method of claim 1 further comprising implementing a Hamming window on the fringe pattern prior to fitting the fringe pattern to the Gaussian distribution, wherein implementing a Hamming window reduces noise in the Gaussian distribution.

4. The method of claim 1, wherein the pattern is a cross-correlation of two interferometric fringe patterns.

5. The method of claim 1, wherein the selected value is the maximum value.

6. The method of claim 1 further comprising: providing a substrate having a compartment formed therein for reception of the liquid and injecting the liquid into the compartment; directing a coherent light beam onto the substrate such that the light beam is incident on the compartment containing the liquid to generate backscattered light; and detecting the backscattered light, wherein the backscattered light comprises a fringe pattern whose position may shift in response to changes in the refractive index of the liquid.

7. The method of claim 1, wherein the step of detecting is carried out by a photodetector having a pixel resolution.

8. The method of claim 7, wherein the positional shifts identified are sub-pixel in resolution.

9. The method of claim 6, wherein the coherent light beam is a laser.

10. The method of claim 9, wherein the laser has a diameter of 2 mm or less.

11. The method of claim 1 further comprising measuring the temperature of the liquid from the change in refractive index of the liquid.

12. The method of claim 1 further comprising monitoring a first and second biochemical species and whether the first and second biochemical species interact with one another by monitoring the change in refractive index of the liquid.

13. The method of claim 12, wherein the first and second biochemical species are selected from the group comprising complimentary strands of DNA, complimentary proteins and antibody-antigen pairs.

14. The method of claim 1 further comprising monitoring whether a ligand in the liquid binds with one or more receptors by monitoring the change in refractive index of the liquid.

15. The method of claim 1 further comprising analyzing a label-free hybridization reaction in the liquid by analyzing the change in refractive index of the liquid.

16. The method of claim 1 further comprising analyzing a chemical or enzymatic reaction between two or more molecules by monitoring the change in refractive index of the liquid.

17. The method of claim 1 further comprising analyzing a structural or conformational change of a molecule by monitoring the change in refractive index of the liquid.

18. A system for determining a characteristic property of a liquid comprising:
a. a device configured to detect a fringe pattern generated from the liquid; and
b. a processor configured to receive information from the device, wherein the processor is configured to execute a set of instructions for processing the fringe pattern at more than one time by fitting the fringe pattern to a Gaussian distribution.

19. The system of claim 18, wherein the processor is a component of a computer system.

20. The system of claim 19, wherein the computer system is configured to control the operation of the device.

21. The system of claim 18, wherein the set of instructions when executed subject the fringe pattern to a Hamming window analysis prior to fitting the fringe pattern to a Gaussian distribution.

22. The system of claim 18, wherein the processor is configured to execute a set of instructions that when executed compare fringe patterns at a first time to fringe patterns at a second time.

23. The system of claim 22, wherein the device has a pixel resolution and the comparison of fringe patterns at the first and second times has a sub-pixel resolution.

24. The system of claim 18, wherein the device is an interferometer.

25. The system of claim 18, wherein the interferometer comprises:
a. a coherent light source; and
b. a sample compartment for receiving the liquid, wherein the compartment is configured for analysis of the liquid therein by back-scatter interferometry when interrogated by a coherent light beam from the coherent light source.

26. A method comprising:
a. collecting data corresponding to a positional shift of a fringe pattern from an interferometer, wherein the data extends over more than one period;
b. fitting the data to an arcsine function using a computer system; and
c. converting the arcsine function of the data with the computer system to a line with a positive slope when the data is increasing and a negative slope when the data is decreasing.

27. The method of claim 26 further comprising:
d. normalizing the data before fitting the data to the arcsine function; and
e. correcting for the normalization after converting the arcsine function of the data to the line.

28. The method of claim 26, wherein the step of converting the arcsine function of the data to a line comprises cumulatively adding the positive change in value for positive slope portions and the positive change of inverse of the change in value of the negative slope portions to the positive portions when the data is increasing.

29. A method comprising:
a. monitoring data corresponding a positional shift in a fringe pattern over time measured from a liquid, wherein the positional shift changes direction at a point in time;
b. performing a linearization of the data, thereby creating a line with a positive slope when the positional shift is increasing and a negative slope when the positional shift is decreasing.

30. The method of claim 29 further comprising:
c. identifying a change in refractive index of the liquid from the line.

31. The method of claim 29 further comprising:
c. normalizing the data before performing the step of linearizing; and
d. correcting for the normalization before the step of identifying.

32. A method comprising: linearizing inferometric data that extends over at least two periods with a computer system; and analyzing the interferometric data set.

33. A system comprising:
a) an optical assembly configured to generate backscattered light comprising a fringe pattern from a sample;
b) an optical detector configured to capture first data about the fringe pattern generated at a first time and second data about the fringe pattern generated at a second time;
c) a signal analyzer configured to receive the first and second data from the optical detector into memory and comprising computer-executable code that:
(i) performs a cross correlation on each image in memory with a reference data and fits a Gaussian distribution to each cross correlation; and
(ii) determines selected values of the Gaussian distributions of the cross correlations, wherein the selected values indicate a position of the fringe pattern.

34. The system of claim 33 wherein the first and second data comprise first and second images of the fringe pattern.

35. The system of claim 33 wherein the system further comprises:
d) a display configured to display the selected values in a format indicating the relative positions of the fringe patterns at the first and second times.

36. The system of claim 33 wherein:
(c) the signal analyzer further comprises computer-executable code that:
(iii) determines from the selected values a change in the position of the fringe patterns;
and the system further comprises a display configured to display the change.

37. A system comprising:
a) an optical assembly configured to generate backscattered light comprising a fringe pattern from a sample;
b) an optical detector configured to capture data about the fringe pattern generated over a time during which the fringe pattern shifts over more than one period;
c) a signal analyzer configured to receive into memory the data from the optical detector; and comprising computer-executable code that:
(i) determines values indicating positions of the fringe pattern over the time;
(ii) fits the values to an arcsine function; and
(iii) converts the fitted values to a line with a positive slope when the values are increasing and a negative slope when the values are decreasing.

38. The system of claim 37 wherein the data comprises an image of the fringe pattern.

39. The system of claim 37 wherein the processor further comprises computer-executable code that:
(iv) normalizes the values before fitting them to the arcsine function; and
(v) corrects for the normalization after converting the arcsine function of the values to the line.

40. The system of claim 37 wherein the system further comprises:
d) a display configured to display at least a portion of the line.

41. The system of claim 37 wherein the signal analyzer further comprises computer executable code that:
(iv) determines from the fitted values points at which the slope of the line changes;
and the system further comprises a display configured to display the points.

42. Computer readable medium comprising computer executable code that:
(i) accesses from computer memory first data about the fringe pattern generated at a first time and second data about the fringe pattern generated at a second time;
(ii) performs a cross correlation on each image in memory with a reference image and fits a Gaussian distribution to each cross correlation; and
(iii) determines selected values of the Gaussian distributions of the cross correlations, wherein the selected values indicate a position of the fringe pattern.

43. The computer readable medium of claim 42 wherein the first and second data are first and second images of the fringe pattern.

44. Computer readable medium comprising computer executable code that:
(i) accesses from computer memory data about a fringe pattern generated over a time during which the fringe pattern shifts over more than one period;
(ii) determines values indicating positions of the fringe pattern over the time;
(iii) fits the values to an arcsine function; and
(iv) converts the fitted values to a line with a positive slope when the values are increasing and a negative slope when the values are decreasing.

45. The computer readable medium of claim 44 wherein the data are images of the fringe pattern.
